(19) United States
(12) Patent Application Publication
(10) Pub. No.: US 2017/0287073 A1
(43) Pub. Date: Oct. 5, 2017

(54) METHODS AND SYSTEMS FOR CREATING A CREDIT VOLATILITY INDEX AND TRADING DERIVATIVE PRODUCTS BASED THEREON

(71) Applicant: Chicago Board Options Exchange, Incorporated, Chicago, IL (US)

(72) Inventors: Antonio Mele, Cimo (CH); Yoshiki Obayashi, New York, NY (US)

(73) Assignee: Chicago Board Options Exchange, Incorporated, Chicago, IL (US)

(21) Appl. No.: 15/628,288

(22) Filed: Jun. 20, 2017

Related U.S. Application Data
(63) Continuation-in-part of application No. 14/722,994, filed on May 27, 2015.
Application No. 14/722,994 is a continuation of application No. 13/841,653, filed on Mar. 15, 2013, now abandoned.
(60) Provisional application No. 61/677,755, filed on Jul. 31, 2012.

(51) Int. Cl. G06Q 40/04; G06Q 40/06

(52) U.S. Cl. CPC G06Q 40/04; G06Q 40/06

(57) ABSTRACT

A computer system for handling missing or infrequent data used for calculating an index is described. The computer system uses the data approximation scheme for calculating a credit volatility index. The computer system includes a memory configured to store at least one program and at least one processor communicatively coupled to the memory, in which the at least one program, when executed by the at least one processor, causes the at least one processor to receive data regarding options and, when data for a complete input data set is missing after a predetermined period, retrieve or generate estimated data points needed to calculate the index. The data points may be for credit default swap index derivatives using data regarding options on credit default swap index derivatives. The processor may generate a credit volatility index and transmit data regarding the credit volatility index.

### CROSS-REFERENCE TO RELATED APPLICATIONS

The present application is a continuation-in-part of U.S. application Ser. No. 14/722,994, filed May 27, 2015, pending, which is a continuation of U.S. application Ser. No. 13/841,653, filed Mar. 15, 2013, abandoned, which claims the benefit of U.S. Provisional App. No. 61/677,755, filed Jul. 31, 2012, wherein the entirety of each of the aforementioned applications is hereby incorporated herein by reference.

### FIELD OF THE DISCLOSURE

The present disclosure relates to electronic systems for handling fixed income derivative investment markets.

### BACKGROUND

Electronic trading platforms are involved in a large amount of the trading activity that takes place in various financial exchanges. Various types of instruments, and data for those instruments, are handled by these electronic trading platforms. One type of instrument traded may be a derivative instrument. A derivative is a financial instrument whose value depends at least in part on the value and/or characteristic(s) of another security, known as an underlying asset. Examples of underlying assets include, but are not limited to: interest rate financial instruments (e.g., bonds and bond futures), credit financial instruments (e.g. corporate bonds, credit default swaps, and credit default swap indexes), commodities, securities, electronically traded funds, and indices. Two exemplary and well-known derivatives are options and futures contracts.

Derivatives, such as options and futures contracts, may be traded over-the-counter and/or on other trading platforms, such as organized exchanges (e.g., the Chicago Board Options Exchange, Incorporated (“CBOE”)). In over-the-counter transactions the individual parties to a transaction are able to customize each transaction to meet each party's individual needs. With trading platform or exchange traded derivatives, buy and sell orders for standardized derivative contracts are submitted to an exchange where they are matched and executed. Generally, modern trading exchanges have exchange specific computer systems that allow for the electronic submission of orders via electronic communication networks, such as the Internet. An example of an exchange specific computer system is illustrated in FIG. 2.

Once matched and executed, the executed trade is transmitted to a clearing corporation that stands between the holders and writers of derivative contracts. When exchange traded derivatives are exercised, the cash or underlying assets are delivered, when necessary, to the clearing corporation and the clearing corporation disperses the assets as appropriate and defined by the consequence(s) of the trades.

An option contract gives the contract holder a right, but not an obligation, to buy or sell an underlying asset at a specific price on or before a certain date, depending on the option style (e.g., American or European). Conversely, an option contract obligates the seller of the contract to deliver an underlying asset at a specific price on or before a certain date, depending on the option style (e.g., American or European). An American style option may be exercised at any time prior to its expiration. A European style option may be exercised only at its expiration, i.e., at a single pre-defined point in time.

There are generally two types of options: calls and puts. A call option conveys to the holder a right to purchase an underlying asset at a specific price (i.e., the strike price), and obligates the writer to deliver the underlying asset to the holder at the strike price. A put option conveys to the holder a right to sell an underlying asset at a specific price (i.e., the strike price), and obligates the writer to purchase the underlying asset at the strike price.

There are generally two types of settlement processes: physical settlement and cash settlement. During physical settlement, funds are transferred from one party to another in exchange for the delivery of the underlying asset. During cash settlement, funds are delivered from one party to another according to a calculation that incorporates data concerning the underlying asset.

A futures contract gives a buyer of the future an obligation to receive delivery of an underlying commodity or asset on a fixed date in the future. Accordingly, a seller of the future contract has the obligation to deliver the commodity or asset on the specified date for a given price. Futures may be settled using physical or cash settlement. Both options and futures contracts may be based on market indicators, such as indices.

A single-name credit default swap (“CDS”) contract gives the buyer insurance against loss arising from a credit event, such as bankruptcy and debt restructuring, of a particular obligor over a fixed period of time in exchange for making periodic premium payments to the seller. A CDS may be settled using physical or cash settlement. A basket CDS contract, also known as a CDS index contract, gives the buyer insurance against loss arising from credit events by any of the multiple single-name constituents during the term of the contract. Whenever a constituent experiences a credit event, the obligor is removed from the basket and the basket continues to be traded with a prorated notional amount.

An index is a statistical composite that is used to indicate the performance of a market or a market sector over various time periods, i.e., act as a performance benchmark. Examples of indices include the Dow Jones Industrial Average, the National Association of Securities Dealers Automated Quotations (“NASDAQ”) Composite Index, and the Standard & Poor's 500 (“S&P 500®”). As noted above, options on indices are generally cash settled. For example, using cash settlement, a holder of an index call option receives the right to purchase not the index itself, but rather a cash amount equal to the value of the index multiplied by a multiplier, e.g., $100. Thus, if a holder of an index call option exercises the option, the writer of the option must pay the holder, provided the option is in-the-money, the difference between the current value of the underlying index and the strike price multiplied by a multiplier. Indexes often depend on the timely availability of data on the constituent items that are used as the input set for calculating and re-calculating the particular index.

Among the indices that derivatives may be based on are those that gauge the volatility of a market or a market subsection. For example, CBOE created and disseminates the CBOE Volatility Index® or VIX®, which is a key measure of market expectations of near-term volatility conveyed by S&P 500 stock index options prices. Additionally, CBOE offers exchange traded derivative products (both futures and options) that use the VIX index as the underlying asset.

Volatility indices and the derivative products based thereon have been widely accepted by the financial industry as both a useful tool to hedge positions and as a device for expressing investment views on the direction of volatility. Certain indices, however, may be difficult for an electronic trading system to generate when there is significant lag time in obtaining trading data used as input information into the algorithm needed to generate the particular index. This lag time may be due to a low frequency of trading in the underlying instruments used in the particular index, or may be due to the lack of access to all of the trading data due to the decentralized manner of trading the underlying instruments, as for example with some trades in over the counter (OTC) markets. In either instance, prices of the underlying instruments feeding the particular index may not get refreshed with regularity in a synchronized way.

### BRIEF SUMMARY

Potential technical problems raised by this data reliability or frequency gap may include the delay in updating the index while waiting for the missing information. This delay in receiving certain inputs (e.g. trade data for a particular strike that forms part of the index input) for the calculation may need to be balanced against the processing time and system overhead needed to constantly generate estimates of current values of trades that have not occurred, or are not known, for certain constituent instruments making up the index. Another technical problem raised by the data reliability and frequency issues for an index that include less frequently traded securities, or for an index using non-centralized trade data, is the need to identify which constituent instruments require generation of an approximate value and which constituent instruments have actual data that is good enough to allow the system to avoid the overhead of calculating approximated values. The systems and processes described herein address the technical problems that arise as a result of the electrification of the markets and the need for systems to process incomplete sets of data with reliability and efficiency while operating in low latency environments. And, to the extent gaps or delays occur with data, the systems and processes create mechanisms to evaluate existing stored pricing data, estimate pricing data where incoming or stored pricing data is unreliable or inconsistent, and determine whether the aggregation of incoming or stored pricing data, and/or estimated pricing data, should cause systems (e.g., electronic trading platform and processors embodied therein) to create a new volatility surface and/or calculate a new index value.

The inventors have also appreciated that, while several volatility indices exist, there currently exists no implementation of a volatility gauge for credit default swaps (“CDSs”) or CDS indexes that is theoretically consistent with prices prevailing in existing markets for options on credit derivatives such as single-name CDS and CDS indexes. Particularly, no standardized benchmarks exist to estimate credit volatility over a given investment horizon and term of the credit derivative. Because no standardized benchmark currently exists that reflects the option-implied fair market value of expected credit volatility, traders, other market participants, and/or money managers currently trade options on CDS to hedge other financial positions, facilitate market-making, and/or take particular investment positions related to market volatility. However, the strategies employed in attempting to hedge risk via the trading of options on CDS and CDS indexes do not necessarily lead to accurate profits and losses due to price dependency, i.e., the tendency to generate profits and losses that are affected by the path of price movements between trade inception and expiry dates rather than the absolute price level prevailing at the time of option expiry.

As such, some embodiments of the invention provide techniques for calculating an index where there is a paucity of trading information or a lack of frequency of trades of the underlying instruments for which trade prices are used in the particular index algorithm. Described below are embodiments where pre-processing steps may be performed and extrapolations on missing information may be generated to permit timely and effective generating of a usable index. In the discussion below, the particular indexes described relate to a volatility index related to credit. Additionally, some embodiments of the invention provide techniques for instantiating and/or facilitating trading of derivative products based on such an index.

In some embodiments, techniques are provided for creating and disseminating one or more volatility indices calculated using data for options on credit derivatives (i.e., an option granting its owner the right but not the obligation to enter into an underlying credit derivative contract), and facilitating the electronic creation and trading of derivative products based on one or more indices relating to volatility.

Additional features and advantages of the invention will be set forth in the description that follows, and in part will be apparent from the description, or may be learned by practice of the invention. The objectives and advantages of the invention will be realized and attained by the method that is particularly pointed out in the written description and claims hereof as well as the appended drawings.

To achieve these and other advantages, and in accordance with the purpose of the invention, as embodied and broadly described, the present invention provides a computer system for avoiding delays in updating an index calculation including memory configured to store at least one program, at least one processor communicatively coupled to the memory for executing the program. The program, when executed by the at least one processor, configures the at least one processor to receive new option trade data for one of a plurality of constituent options needed for a complete data set of option trade data utilized in a credit volatility index equation. The processor is also configured by the program to refresh an index when an index refresh period has elapsed, where the index refresh period is a predetermined period of time for receiving new option trade data for the plurality of constituent options, and new option trade data for all of the plurality of constituent options has not been received, utilize the received new option trade data for the one of the plurality of constituent options to generate respective estimated new option trade data for each of a remainder of the plurality of constituent options. The processor is also configured to then calculate, using the received new option trade data and the estimated new option trade data for the plurality of constituent options, a credit volatility index. In some embodiments the data regarding options on credit default swap index derivatives includes data regarding prices of options on credit default swap index derivatives.

In some embodiments the data regarding prices of options on credit default swap index derivatives includes data regarding prices of European style options on credit default swap index forwards.

In some embodiments the data regarding prices of options on credit default swap index derivatives includes data regarding prices of options that are not European style options on credit default swap index forwards.

In some embodiments when the data regarding prices of options on credit default swap derivatives includes data regarding prices of options that are not European-style options on credit default swap index forwards, converting the data regarding prices of options that are not European-style options on credit default swap index forwards to data regarding prices of European style options on credit default swap index forwards.

In some embodiments calculating the credit volatility index includes valuing a basket of options on the credit default swap derivatives required for model-independent pricing of a variance swap contract on the credit default swap derivatives.

In another embodiment, the credit volatility index is calculated at time t according to the equation:

$$C - VI ( t , T , M ) ≡ 100 \sqrt{\begin{matrix}\frac{1}{( T - t )} [ \frac{2}{{v}_{1 , t}} [ {\sum }_{i : Ki < {K}_{*}} \frac{{SW}_{t}^{r} ( {K}_{i} , T ; M )}{{K}_{i}^{2}} Δ {K}_{i} + \\ {\sum }_{i : Ki < {K}_{*}} \frac{{SW}_{t}^{p} ( {K}_{i} , T ; M )}{{K}_{i}^{2}} Δ {K}_{i} ] - {( \frac{{CDX}_{t} ( T , M ) - {K}_{*}}{{K}_{*}} )}^{2} ]\end{matrix}}$$

wherein:

t denotes a time at which the credit volatility index is calculated;

T denotes a time of expiry of options on credit default swap indexes;

M denotes a time of expiry of credits default swap indexes;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

ΔKᵢ=½(Kᵢ₊₁−Kᵢ₋₁) for i≧1, and ΔK₀=(K₁−K₀),ΔK_{Z}=(K_{Z}−K_{Z-1});

if the price is observable at time t, then CDXₜ(T,M) is a price at time t of a credit default swap index derivative, expiring at T, with an underlying credit default swap index maturing at M;

if the price is not observable at time t, then CDXₜ(T,M) is the spread at which the difference between the put and call prices is smallest;

if there exists an option struck at CDXₜ(T,M), then K_{*} equals CDXₜ(T,M);

if there does not exist an option struck at CDXₜ(T,M), then K_{*} is the first available strike below CDXₜ(T,M);

v_{1,t} is a price value of a basis point at time t, adjusted for default risk, of the credit default swap index premium payments;

SWₜ^{r} (Kᵢ,T;M) is a price at time t of a receiver option, struck at Kᵢ, expiring at T, and having an underlying credit default swap index derivative expiring at T_{D} with an underlying credit default swap index maturing at M;

SWₜ^{p}(Kᵢ,T;M) is a price at time t of a payer option, struck at Kᵢ, expiring at T, and having an underlying credit default swap index derivative expiring at T_{D} with an underlying credit default swap index maturing at M; and

C-VI(t,T,M) is the value of the credit volatility index at time t calculated based on options expiring at T with an underlying credit default swap index maturing at M.

In some embodiments the credit volatility index is calculated at time t according to the equation:

$$C - {VI}^{bp} ( t , T , M ) ≡ {100}^{2} \sqrt{\begin{matrix}\frac{1}{( T - t )} [ \frac{2}{{v}_{1 , t}} [ {\sum }_{i : Ki < {K}_{*}} {SW}_{t}^{r} ( {K}_{i} , T ; M ) Δ {K}_{i} + \\ {\sum }_{i : Ki \geq {K}_{*}} {SW}_{t}^{p} ( {K}_{i} , T ; M ) Δ {K}_{i} ] - {( {CDX}_{t} ( T , M ) - {K}_{*} )}^{2} ]\end{matrix}}$$

wherein:

t denotes a time at which the credit volatility index is calculated;

T denotes a time of expiry of options on credit default swap indexes;

M denotes a time of expiry of credit default swap indexes;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

ΔKᵢ=½(Kᵢ₊₁−Kᵢ₋₁) for i≧1, and ΔK₀=(K₁−K₀),ΔK_{Z}=(K_{Z}−K_{Z-1});

if the price is observable at time t, then CDXₜ(T,M) is a price at time t of a credit default swap index derivative, expiring at T, with an underlying credit default swap index maturing at M;

if the price is not observable at time t, then CDXₜ(T,M) is the spread at which the difference between the put and call prices is smallest;

if there exists an option struck at CDXₜ(T,M), then K_{*} equals CDXₜ(T,M);

if there does not exist an option struck at CDXₜ(T,M), then K_{*} is the first available strike below CDXₜ(T,M);

v_{1,t} is a price value of a basis point at time t, adjusted for default risk, of the credit default swap index premium payments;

SWₜ^{r} (Kᵢ,T;M) is a price at time t of a receiver option, struck at Kᵢ, expiring at T, and having an underlying credit default swap index maturing at M;

SWₜ^{p}(Kᵢ,T;M) is a price at time t of a payer option, struck at Kᵢ, expiring at T, and having an underlying credit default swap index derivative expiring at T_{D} with an underlying credit default swap index maturing at M; and

C-VI^{bp}(t,T,M) is the value of the credit volatility index at time t calculated based on options expiring at T on credit default swap index derivatives expiring at T with an underlying credit default swap index maturing at M.

In some embodiments the at least one processor is further caused to create a standardized exchange-traded derivative instrument based on the credit volatility index; and transmit data regarding the standardized exchange-traded derivative.

In some embodiments transmitting data regarding the standardized exchange-traded derivative instrument includes transmitting data regarding one or more of a settlement price, a bid price, an offer price, or a trade price of the standardized exchange-traded derivative instrument.

In another embodiment, a non-transitory computer readable storage medium having computer-executable instructions recorded thereon that, when executed on a computer, configure the computer to perform a method to calculate a credit volatility index, the method comprising receiving data regarding options on credit default swap index derivatives; calculating, using the data regarding options on credit default swap index derivatives, the credit volatility index; and transmitting data regarding the credit volatility index.

In some embodiments of the non-transitory computer readable storage medium the data regarding options on credit default swap index derivatives includes data regarding prices of options on credit default swap index derivatives.

In some embodiments of the non-transitory computer readable storage medium the data regarding prices of options on credit default swap index derivatives includes data regarding prices of European style options on credit default swap index forwards.

In some embodiments of the non-transitory computer readable storage medium the data regarding prices of options on credit default swap index derivatives includes data regarding prices of options that are not European-style options on credit default swap index forwards.

In some embodiments of the non-transitory computer readable storage medium when the data regarding prices of options on credit default swap index derivatives includes data regarding prices of options that are not European-style options on credit default swap index forwards, converting the data regarding prices of options that are not European-style options on credit default swap index forwards to data regarding prices of European style options on credit default swap index forwards.

In some embodiments of the non-transitory computer readable storage medium calculating the credit volatility index includes valuing a basket of options on the credit default swap index derivatives required for model-independent pricing of a variance swap contract on the credit default swap index derivatives.

In some embodiments of the non-transitory computer readable storage medium, the credit volatility index is calculated at time t according to the equation:

$$C - VI ( t , T , M ) ≡ 100 \sqrt{\begin{matrix}\frac{1}{( T - t )} [ \frac{2}{{v}_{1 , t}} [ {\sum }_{i : Ki < {K}_{*}} \frac{{SW}_{t}^{r} ( {K}_{i} , T ; M )}{{K}_{i}^{2}} Δ {K}_{i} + \\ {\sum }_{i : Ki \geq {K}_{*}} \frac{{SW}_{t}^{p} ( {K}_{i} , T ; M )}{{K}_{i}^{2}} Δ {K}_{i} ] - {( \frac{{CDX}_{t} ( T , M ) - {K}_{*}}{{K}_{*}} )}^{2} ]\end{matrix}}$$

wherein:

t denotes a time at which the credit volatility index is calculated;

T denotes a time of expiry of options on credit default swap indexes;

M denotes a time of expiry of credits default swap indexes;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

ΔKᵢ=½(Kᵢ₊₁−Kᵢ₋₁) for i≧1, and ΔK₀=(K₁−K₀),ΔK_{Z}=(K_{Z}−K_{Z-1});

if the price is observable at time t, then CDXₜ(T,M) is a price at time t of a credit default swap index derivative, expiring at T, with an underlying credit default swap index maturing at M;

if the price is not observable at time t, then CDXₜ(T,M) is the spread at which the difference between the put and call prices is smallest;

if there exists an option struck at CDXₜ(T,M), then K_{*} equals CDXₜ(T,M);

if there does not exist an option struck at CDXₜ(T,M), then K_{*} is the first available strike below CDXₜ(T,M);

v_{1,t} is a price value of a basis point at time t, adjusted for default risk, of the credit default swap index premium payments;

SWₜ^{r} (Kᵢ,T;M) is a price at time t of a receiver option, struck at Kᵢ, expiring at T, and having an underlying credit default swap index maturing at M;

SWₜ^{p} (Kᵢ,T;M) is a price at time t of a payer option, struck at expiring at T, and having an underlying credit default swap index maturing at M; and

C-VI(t,T,M) is the value of the credit volatility index at time t calculated based on options expiring at T with an underlying credit default swap index maturing at M.

In some embodiments of the non-transitory computer readable storage medium, the credit volatility index is calculated at time t according to the equation:

$$C - {VI}^{bp} ( t , T , M ) ≡ {100}^{2} \sqrt{\begin{matrix}\frac{1}{( T - t )} [ \frac{2}{{v}_{1 , t}} [ {\sum }_{i : Ki < {K}_{*}} {SW}_{t}^{r} ( {K}_{i} , T ; M ) Δ {K}_{i} + \\ {\sum }_{i : Ki \geq {K}_{*}} {SW}_{t}^{p} ( {K}_{i} , T ; M ) Δ {K}_{i} ] - {( {CDX}_{t} ( {T}_{D} , M ) - {K}_{*} )}^{2} ]\end{matrix}}$$

wherein:

t denotes a time at which the credit volatility index is calculated;

T denotes a time of expiry of options on credit default swap indexes;

M denotes a time of expiry of credits default swap indexes;

Z+1 denotes a total number of options used in the index calculation;

K₀ denotes the lowest strike of the Z+1 options;

Kᵢ denotes the i^{th} highest strike of the Z+1 options;

K_{Z} denotes the highest strike of the Z+1 options;

ΔKᵢ=½(Kᵢ₊₁−Kᵢ₋₁) for i≧1, and ΔK₀=(K₁−K₀),ΔK_{Z}=(K_{Z}−K_{Z-1});

if the price is observable at time t, then CDXₜ(T,M) is a price at time t of a credit default swap index derivative, expiring at T, with an underlying credit default swap index maturing at M;

if the price is not observable at time t, then CDXₜ(T,M) is the spread at which the difference between the put and call prices is smallest;

if there exists an option struck at CDXₜ(T,M), then K_{*} equals CDXₜ(T,M);

if there does not exist an option struck at CDXₜ(T,M), then K_{*} is the first available strike below CDXₜ(T,M);

v_{1,t} is a price value of a basis point at time t, adjusted for default risk, of the credit default swap index premium payments;

SWₜ^{r}(Kᵢ,T;M) is a price at time t of a receiver option, struck at Kᵢ, expiring at T, and having an underlying credit default swap index maturing at M;

SWₜ^{p}(Kᵢ,T;M) is a price at time t of a payer option, struck at Kᵢ, expiring at T, and having an underlying credit default swap index maturing at M; and

C-VI^{bp}(t,T,M) is the value of the credit volatility index at time t calculated based on options expiring at T with an underlying credit default swap index maturing at M.

In some embodiments of the non-transitory computer readable storage medium the at least one processor is further caused to create a standardized exchange-traded derivative instrument based on the credit volatility index; and transmit data regarding the standardized exchange-traded derivative.

In some embodiments of the non-transitory computer readable storage medium transmitting data regarding the standardized exchange-traded derivative instrument includes transmitting data regarding one or more of a settlement price, a bid price, an offer price, or a trade price of the standardized exchange-traded derivative instrument.

The foregoing is a non-limiting summary of the invention, some embodiments of which are defined by the attached claims.

### BRIEF DESCRIPTION OF THE DRAWINGS

FIG. 1 is a flow chart illustrating how an options-based credit volatility index may be calculated and updated in real-time despite intermittent and incomplete price discovery in the underlying options market.

FIG. 2 is a diagram of a financial exchange's computerized trading system;

FIG. 3 is a diagram of a financial exchange's back end trading system;

FIG. 4 is a flow diagram of a method of calculating a Basis Point Credit Volatility Index;

FIG. 5 is a flow diagram of a method of calculating a Percentage Credit Volatility Index; and

FIG. 6 is a diagram of a general purpose computer system that can be modified via computer hardware or software to be customized and specialized so as to be suitable for use in a financial exchanges computerized trading system.

### DETAILED DESCRIPTION

In a perfect market, continuous pricing information for each strike would be available for use by market participants to determine an index value using a credit volatility algorithm to assist with trade activity. However, where there is currently an imperfect market functioning on imperfect information, for example like the case for an over-the-counter (OTC) market, there may be no centralized data aggregation and/or there may be infrequent information updates on trade activity due to lack of trading activity.

In the context of the credit volatility index addressed below, the market imperfection may occur because there are times when there is no pricing data, or the pricing data that does exist is outdated or obsolete, for some strikes that should be included as inputs to the credit volatility algorithm disclosed herein. This “gap” in pricing data may be the result of not having a clear picture of the entire market or because the data just doesn't exist. As described herein, methods and systems are provided to address technical problems that are associated with consistently and reliably calculating an index and addressing gaps or lapses in pricing data.

Potential technical problems raised by this data reliability or frequency gap may include the delay in updating the index while waiting for the missing information. Historically, higher frequency data, such as data in increments down to multiple seconds or even sub-second data, would have gone by unnoticed in favor of a single daily calculation. However, as market participants desire indexes that are updated more and more frequently, the data gaps and delays become noticeable and may be significant. The need for fast and reliable data creates a technical challenge due to delays in receiving certain inputs (e.g., trade data for a particular strike that forms part of the index input), and also creates computational challenges in the form of overhead in calculating estimated pricing data for use in an index calculation, wherein the estimated pricing data may include generated estimates of current values of trades that have not occurred, or are not known, for certain constituent instruments making up the index. This computational overhead, which includes processing time and computational cycles, must be balanced against the accuracy of the existing pricing data, the need to generate new estimated pricing data, the amount of delay in receiving new pricing data, the need to calculate or recalculate a volatility surface based on the existing, new, and/or estimated pricing data, the impact that estimated pricing data has or would likely have on the index calculation, as well as a number of other factors.

Another technical problem raised by the data reliability and frequency issues for an index that include less frequently traded securities, or for an index using non-centralized trade data, is the need to identify which constituent instruments require generation of an approximate value and which constituent instruments have actual data that is good enough to allow the system to avoid the overhead of calculating approximated values.

In order to address the technical problems found in an index, such as the credit volatility index described below, a method and system for calculating and updating an options-based credit volatility index is described. The method and system may calculate and update the options-based credit index in real-time despite intermittent and patchy price discovery in an underlying options market, which would have made the calculation impracticable if not impossible prior to the advent of specialized computing devices. As mentioned above, trading in options on credit default swap (CDS) indexes often takes place in a decentralized fashion (i.e., through over-the-counter (OTC) markets) and price discovery is not nearly as complete or continuous as may be the case for other instruments, such as exchange-listed options on the S&P 500. Even exchange-traded indexes may occasionally run into issues of sparse price discovery or patchy quoting that can lead to gaps in information.

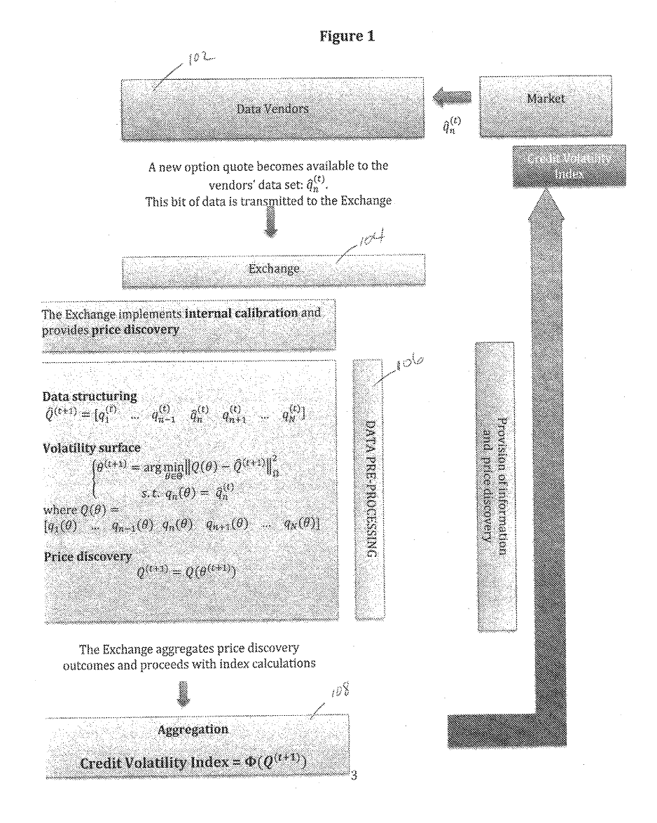

A process for addressing the technical problems of gaps in information needed to generate an index in a consistent and timely manner is illustrated in FIG. 1. In the simplified example of FIG. 1, a credit volatility index is calculated based on a fixed number of option prices, for example N. At time t, a new action (such as a quote, bid, order or trade) takes place on the n-th option of the 1 to N options at a price equal to \hat{q}ₙ^{(t)}. This action may come from, for example, one or more participants in an all-electronic or hybrid market. Information about the action is transmitted to the computer server(s) 102 of one or more data aggregators/vendors via an API, and the computer server(s) 102 transmits (e.g., using one or more communication devices and/or protocols) the information to an electronic trading platform (e.g., an exchange) 104 or some other electronic calculation agent of the credit volatility index. The electronic trading platform 104 collects the information about the actions (including the pricing data associated therewith) and stores the data in storage.

In response to receiving this new piece of information regarding the n-th option price, the electronic trading platform would typically update the overall index value, but the electronic trading platform 104 may not have information about what the arrival of a new price for the n-th option implies regarding the prices of the other N−1 options. The electronic trading platform 104 is faced with the problem that the last-observed prices for the other N−1 options may not be representative of market conditions in light of the new price of the n-th option. Moreover, even if, amongst the N−1 remaining options, those with a strike sufficiently away from the n-th option (e.g., within a certain threshold) should not be affected by new market forces leading to the new price for the n-th option, it may be that options for strikes surrounding the n-th option are no longer representative of the market conditions in light of the new price of the n-th option.

One way to address such problems includes the electronic trading platform 104 implementing a data pre-processing step 106 performed on the electronic trading platform 104 that is triggered by, for example, the arrival of new price data, arrival of a threshold amount of data, upon the passage of a certain amount of time, etc. As part of pre-processing step 106, electronic trading platform 104 includes a calibration function used to ensure proper data model constraints are met. For instance, the calibration function may consider the number of quotes that can be used to create an index price. The number of quotes may vary based on the type of index, whether the quotes are around the same or similar strikes, the number of quotes missing between strikes, etc. The pre-processing step 106 may also identify a time parameter associated with a quote and, based at least in part on the time elapsed since the time parameter, identify whether to use an existing price or determine an estimated price for use in creating an index. The pre-processing step 106 may create one or more volatility surfaces to identify and analyze the impact of the new price data. In an example, pre-processing step 106 can use analytics tools to identify trends in pricing data (such as received quotes) and predict future pricing data trends that can be used to estimate pricing data. Price discovery leads to estimated prices for the remaining options in light of the information provided by the new quote for the n-th option.

With respect to the output from pre-processing step 106, which may be software, hardware or a combination of both in the electronic trading platform 104, the software and/or hardware can be structured to obtain or store pricing data, estimated pricing data, timing data, trend data, volatility data, as well as analytics performed at pre-processing step 106. The output can be aggregated to calculate and distribute a new index value (“Aggregation and information provision”). The aggregation step 108 may be completed on the processor of the electronic trading platform 104, and use all or part of the output from the pre-processing 106 as input data in creating a particular index.

Phase I: Data Pre-Processing

During this phase, the Exchange 104 first restructures the data to include the new option price, \hat{q}ₙ^{(t)}. The dataset at the basis of the new index calculations is \hat{Q}^{(t+1)}. This dataset includes the old option prices, q₁^{(t)}, . . . , qₙ₋₁^{(t)}, qₙ₊₁^{(t)}, . . . , q_{N}^{(t)} (that is, the price of the options that were traded prior to the n-th option) as well as the new option price, \hat{q}ₙ^{(t)} (that is, the price of the option traded at time-t). It is also possible that more than one new options price is observed between refresh intervals and not just a single n-th option.

The second step in this phase involves an options pricing model that describes the no-arbitrage relationship between the N options. This step is called “volatility surface” because its objective is to calibrate parameters, some of which are related to volatility, such that the model explains how the prices of the N−1 other options should change given the new information about the nth option.

The Exchange calibrates the model's parameters (θ) to ensure that the model predictions are as close as possible to the dataset, \hat{Q}^{(t+1)}, with the constraint that the model must match the exact price of the new option quote, \hat{q}ₙ^{(t)}. All the option prices predicted by the model for a given parameter θ is denoted by Q(θ). The parameter that matches the model to the new dataset [symbol] ((t+1)) is denoted by θ^{(t+1)}. In one implementation, the model may either match the new quote or be within a predetermined tolerance amount of it.

This final step of this phase is called “price discovery.” By using the calibrated parameters from the step above, θ^{(t+1)}, the model outputs new prices for the N−1 untraded options, Q(θ^{(t+1)}).

Phase II: Aggregation and Information Provision

The Exchange 104 calculates an index by aggregating the prices obtained in the previous phase, Q^{(t+1)} with a formula, Φ(Q^{(t+1)}). Finally, the Exchange 104 transmits the new values of the credit volatility index to the market, thereby making its own price discovery process public. Some embodiments of the present invention can be implemented on financial exchange systems and/or other known financial industry systems, whether now known or later developed. Typically, financial exchange systems and other known financial industry systems utilize a combination of computer hardware (e.g., client and server computers, which may include computer processors, memory, storage, input and output devices, and other known components of computer systems; electronic communication equipment, such as electronic communication lines, routers, switches, etc.; electronic information storage systems, such as network-attached storage and storage area networks) and computer software (i.e., the instructions that cause the computer hardware to function in a specific way) to achieve the desired system performance. It should be noted that financial exchange systems may be floor-based open outcry systems, pure electronic systems, or some combination of floor-based open outcry and pure electronic systems.

In different implementations, the existence of a gap in the received trade data on the underlying instruments that make up the complete data set used by the credit volatility index algorithm (or other index algorithm) may be determined based on a predetermined index refresh period. The predetermined index refresh period may be a set period of time within which the index needs to be recalculated. The predetermined index refresh period may be, for example, a rolling 15 second time frame, within which the electronic trading platform waits for any new trade information on constituent derivatives (e.g., credit default swap derivatives) and then recalculates the index. Alternatively, the predetermined index refresh period may be a period of time that starts from receipt of new trade price data for any of the constituent derivatives in the input data set since the last recalculation of the index. The period of time and the refresh period trigger may be any of a number of desired predetermined factors in different implementations.

In yet other embodiments, rather than estimate new trade data of the constituent derivatives that have not had any trading activity during the index refresh period, the electronic trading platform 104 may decide to recalculate only a portion of the missing data points and use existing or historical data for other of the constituent derivatives. For example, if the electronic trading platform 104 receives new trade data from one or more data sources at time to, the electronic trading platform 104, or data input engine of that electronic trading platform 104, may perform some error checking, source validation, etc. on the data before sending the data to the data pre-processing module 106 of the electronic trading platform. The data pre-processing module 106 may determine (e.g., via parsing and sorting methods) what strikes in the complete input data set of strikes for the index algorithm have actual pricing data and what strikes are missing actual pricing data for the particular index refresh period. For those strikes that are missing actual pricing data, the data pre-processing module 106 may send a data request to a database in, or in communication with, the electronic trading platform to obtain a proxy value for each strike missing price data. In some examples, the database may return a single proxy value for each strike representing the last actual price or a calculated proxy value for the strike. In other examples, the database may return historical price data and/or historical proxy values for each strike, which the analytics engine may use to calculate the proxy value for each strike, e.g., using a historical average, weighted average, or other method such as the method of calculating a complete volatility surface to determine the effect of a single input change on all other constituent data point inputs as described with respect to FIG. 1. The electronic trading platform 104 or data pre-processing module 106 can store the proxy values in a first memory location and actual pricing data in a second memory location.

The data pre-processing module 106 may continue to receive data from time t0 to time tN where the difference between t0 and tN is less than the index refresh period (also referred to as the index calculation frequency) (e.g., less than 15 seconds). This index refresh period can be sub-second, span multiple seconds and/or minutes. As data is continually received, the data pre-processing module 106 continues to determine (e.g., via parsing and sorting methods) what strikes have actual pricing data and compares the newly received actual pricing data for a strike with the proxy values for that same strike. If a match occurs, the data pre-processing module 106 may cause the proxy value for the strike to be removed from the first memory location and for the newly received actual pricing data for the strike to be added to the second memory location. In this embodiment, the data pre-processing module 106 need only process a subset of the incoming data from the data input engine, and may reduce calls to memory (and computing cycles) by focusing on a subset of the stored data (i.e., the proxy data) when determining whether an update to memory is needed.

At time tN, the window for receiving data that may be used in the calculation ends. The aggregation module 108 may access the proxy values in the first memory location and the actual pricing data in the second memory location to calculate an index using the index algorithm. In some examples, data from the first memory location and the second memory location may be merged prior to or upon receipt by the index calculator engine. In some examples, the aggregation module 108 may perform one or more quantitative analytics. For instance, the aggregation module 108 may determine (e.g., based on the original memory location) whether a threshold number of strikes have actual pricing data such that the index calculation would consist of a predetermined percentage of actual prices and thereby be representative of observed market conditions.

In yet another example, the aggregation module 108 may perform a quantitative analysis of the resultant to determine whether one or more errors may have occurred during the calculation of the index or in the selection/calculation of the proxy values. Other examples also exist.

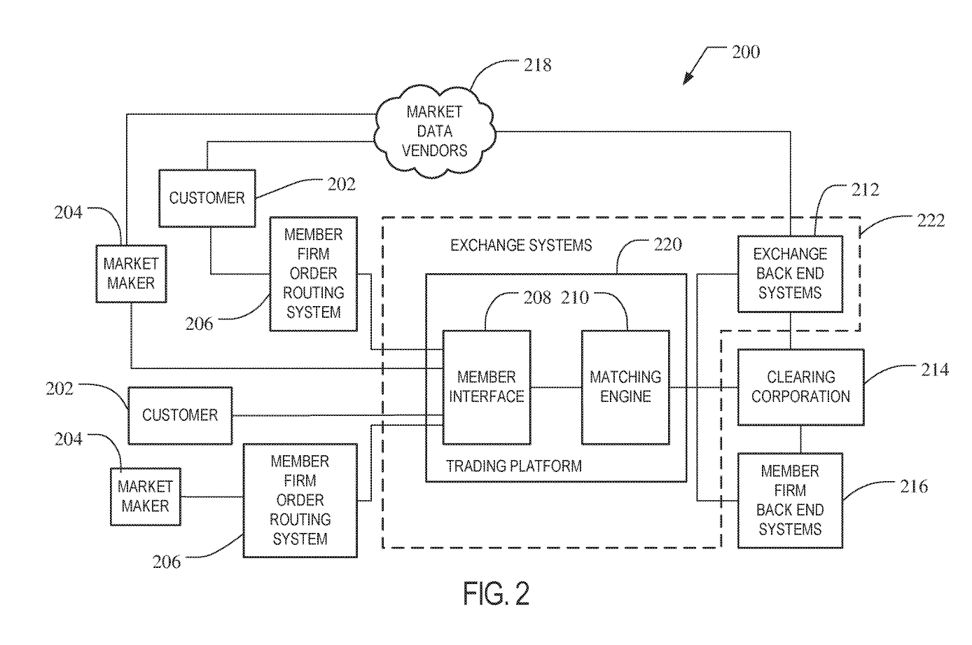

Referring now to FIG. 2, one example of a slightly more detailed electronic trading system 200 is shown which may be used for pre-processing incomplete trading information to generate a CDS index as described in FIG. 1. In addition to creating and disseminating a CDS index option-based index (such as a credit volatility index), the system 200 may be configured for creating, listing and trading derivative contracts that are based on a CDS index option index. One having ordinary skill in the art would readily understand that system 200, as described in detail below, would be implemented utilizing a combination of computer hardware and software, as described above. It will be appreciated that the described systems may implement the methods described below to address the technical challenge of intermittent and incomplete input data in creating an index.

The system 200 includes components operated by an exchange, as well as components operated by others who access the exchange to execute trades. The components shown within the dashed lines are those operated by the exchange. Components outside the dashed lines are operated by others, but nonetheless are necessary for the operation of a functioning exchange. The exchange components 222 of the trading system 200 include an electronic trading platform 220, a member interface 208, a matching engine 210, and backend systems 212. Backend systems not operated by the exchange but which are integral to processing trades and settling contracts are the Clearing Corporation's systems 214, and Member Firms' backend systems 216.

Market Makers may access the trading platform 220 directly through personal input devices 204 which communicate with the member interface 208. Market makers may quote prices for the derivative contracts of the present invention, e.g. credit volatility index derivative contracts. Non-member Customers 202, however, must access the exchange through a Member Firm. Customer orders are routed through Member Firm routing systems 206. The Member Firm routing systems 206 forward the orders to the exchange via the member interface 208. The member interface 208 manages all communications between the Member Firm routing systems 206 and Market Makers' personal input devices 204; determines whether orders may be processed by the trading platform; and determines the appropriate matching engine for processing the orders. Although only a single matching engine 210 is shown in system 200, the trading platform 220 may include multiple matching engines. Different exchange traded products may be allocated to different matching engines for efficient execution of trades. When the member interface 208 receives an order from a Member Firm routing system 206, the member interface 208 determines the proper matching engine 210 for processing the order and forwards the order to the appropriate matching engine. The matching engine 210 executes trades by pairing corresponding marketable buy/sell orders. Non-marketable orders are placed in an electronic order book.

Once orders are executed, the matching engine 210 sends details of the executed transactions to the exchange backend systems 212, to the Clearing Corporation systems 214, and to the Member Firm backend systems 216. The matching engine also updates the order book to reflect changes in the market based on the executed transactions. Orders that previously were not marketable may become marketable due to changes in the market. If so, the matching engine 210 executes these orders as well.

The exchange backend systems 212 perform a number of different functions. For example, contract definition and listing data originate with the Exchange backend systems 212. The CDS index option-based indices of the present invention, e.g., the Credit volatility indices described below, and pricing information for derivative contracts associated with the indices of the present invention are disseminated from the exchange backend systems to market data vendors 218. Customers 202, market makers 204, and others may access the market data regarding the indices of the present invention and the derivative contracts based on the indices of the present invention via, for example, proprietary networks, on-line services, and the like.

The exchange backend systems also evaluate the underlying asset or assets on which the derivative contracts of the present invention are based. At expiration, the backend systems 212 determine the appropriate settlement amounts and supply final settlement data to the Clearing Corporation 214. The Clearing Corporation 214 acts as the exchange's bank and performs a final mark-to-market on Member Firm margin accounts based on the positions taken by the Member Firms' customers. The final mark-to-market reflects the final settlement amounts for the derivative contracts of the present invention, and the Clearing Corporation debits/credits Member Firms' accounts accordingly. These data are also forwarded to the Member Firms' systems 216 so that they may update their customer accounts as well.

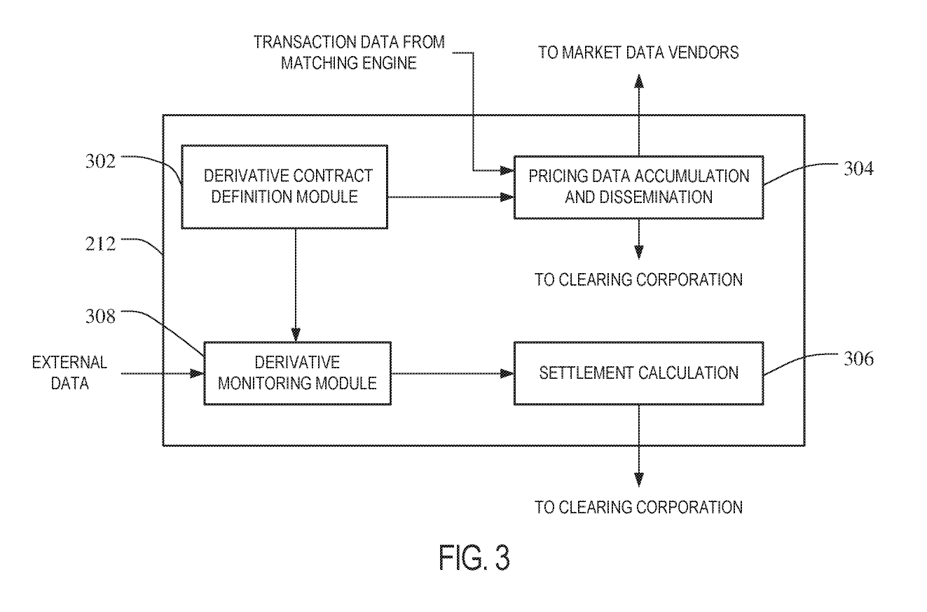

FIG. 3 shows an embodiment of the exchange backend systems 212 used for creating and disseminating an index of the present invention, e.g., a Credit volatility index, and/or creating, listing, and trading derivative contracts that are based on an index of the present invention. A derivative contract of the present invention has a definition stored in module 302 that contains all relevant data concerning the derivative contract to be traded on the trading platform 220, including, for example, the contract symbol, a definition of the underlying asset or assets associated with the derivative, or a term of a calculation period associated with the derivative. A pricing data accumulation and dissemination module 304 receives contract information from the derivative contract definition module 302 and transaction data from the matching engine 210. The pricing data accumulation and dissemination module 304 provides the market data regarding open bids and offers and recent transactions to the market data vendors 218. The pricing data accumulation and dissemination module 304 also forwards transaction data to the Clearing Corporation 214 so that the Clearing Corporation 214 may mark-to-market the accounts of Member Firms at the close of each trading day, taking into account current market prices for the derivative contracts of the present invention. Finally, a settlement calculation module 306 receives input from the derivative monitoring module 308. On the settlement date the settlement calculation module 306 calculates the settlement amount based on the value associated with the underlying asset or assets, e.g., the value of a Credit volatility index. The settlement calculation module 306 forwards the settlement amount to the Clearing Corporation 214, which performs a final mark-to-market on the Member Firms' accounts to settle the derivative contract of the present invention.

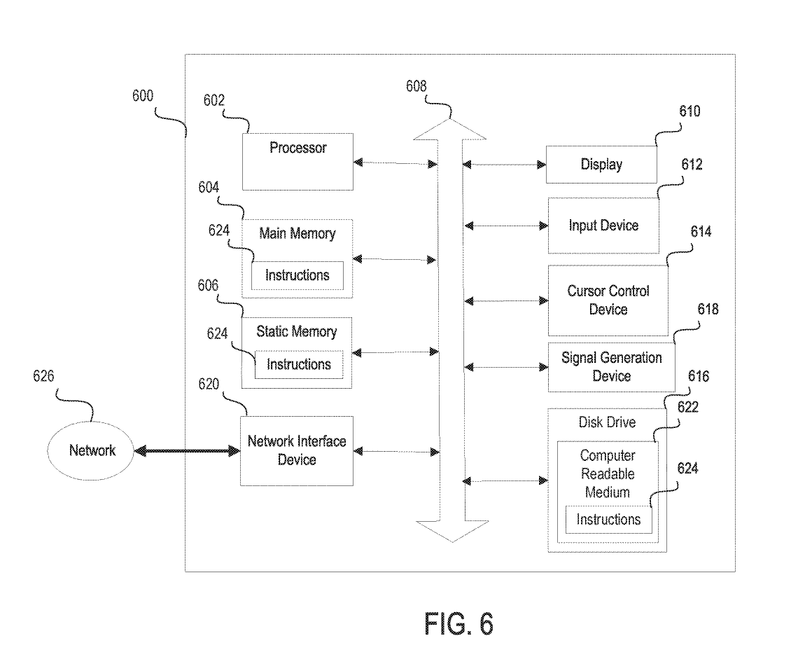

Referring to FIG. 6, an illustrative embodiment of a general computer system that may be used for one or more of the components shown in FIGS. 1-3, or in any other trading system configured to carry out the methods discussed in further detail below, is shown and is designated 600. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (“PC”), a tablet PC, a set-top box (“STB”), a personal digital assistant (“PDA”), a mobile device, a palmtop computer, a laptop computer, a desktop computer, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, such as a central processing unit (“CPU”), a graphics processing unit (“GPU”), or both. Moreover, the computer system 600 can include a main memory 604 and a static memory 606 that can communicate with each other via a bus 608. As shown, the computer system 600 may further include a video display unit 610, such as a liquid crystal display (“LCD”), an organic light emitting diode (“OLED”), a flat panel display, a solid state display, or a cathode ray tube (“CRT”). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g., software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture information communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols commonly used by investment management companies, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

According to one embodiment, systems and methods are provided for calculating and disseminating credit volatility indices. Credit volatility indices (“C-VI”) may be calculated and disseminated using the systems shown in FIGS. 1, 2, and 5 and described in detail above. Generally, the C-VIs reflect the fair value of contracts for delivery of realized volatility of forward CDS index spreads, and reflect the expected volatility of forward CDS index spreads within arbitrary investment horizons. According to embodiments of the present invention, C-VIs can be calculated for any CDS index for which options markets exist. According to an embodiment of the present invention, the C-VI is calculated based on data relating to a market for options on CDS indexes. For example, the C-Vis would be particularly well suited for indexes such as the Markit CDX™ and Markit iTraxx™ indexes owned by Markit Group Limited.

According to some embodiment of the present invention, the C-VIs are calculated, for each maturity-tenor combination (maturity of the option and tenor of the underlying CDS index) on the “volatility surface,” by aggregating the price of at-the-money and out of-the money receiver and payer options on CDS indexes (i.e., the option “skew,” the “volatility skew”) into a single formula, which is independent of any option pricing model. These C-VIs match the prevailing market practices to quote volatility in fixed income markets in terms of either basis point volatility or percentage volatility. Moreover, the C-VIs described herein can reflect the fair market value of contracts for future delivery of CDS index spread volatility, at each point of the volatility surface, i.e., over any arbitrary maturity date and tenor of the CDS index.

According to an embodiment of the present invention, the C-VIs are constructed using the prices of a broad set of CDS index options, including at-the-money and out-of-the money options. Thus, according to an embodiment of the present invention, the C-VIs reduce the dimensions of the “volatility cube” in the CDS index option markets from three down to two, where a three dimensional relationship structure is reduced down to a two dimensional relationship structure. The “volatility cube” represents the relationship between the implied volatility of CDS index options and: (i) time to expiration of the CDS index option, (ii) time to expiration of the CDS index underlying the option, and (iii) the strike of the CDS index option. It is the dimension of the “volatility cube” that represents the relationship between the implied volatility of CDS index options and the strike of the CDS index options that is reduced by collapsing this dimension (iii) into a single point for each combination of dimensions (i)-(ii).

A buyer of protection on a CDS index, also known as basket or portfolio CDS, pays a periodic premium (“CDS index spread”) to the seller in exchange for insurance against losses arising from one or more defaults from a basket of single-name CDS, also known as index constituents, during the term of the contract. Whenever a constituent defaults, the defaulted obligor is removed from the index and the index continues to be traded with a prorated notional amount. Hence, the number of surviving names in the index, S(Tᵢ) at some future date Tᵢ is uncertain and can be expressed as,

$$S ( {T}_{i} ) ≡ {\sum }_{j = 1}^{n} ( 1 - {I}_{\{ τ j \leq {T}_{i} \}} )$$

where n is the starting number at initial time t=T₀ of the index constituents and τⱼ is the random default time of the j-th constituent and I_{{τ}_{ⱼ}_{≦T}_{ᵢ}_{}} is the indicator function that takes a value of 1 if default takes place before Tᵢ.
At initial time t, the value of the CDS index contract for the protection buyer minus that of the protection seller over the life of the contract is

$${DSX}_{t} ≡ {E}_{t} [ {\sum }_{j = 1}^{n} exp ( - {\int }_{t}^{{τ}_{j}} r ( s ) ds ) ( LGD \frac{1}{n} {I}_{\{ t \leq {τ}_{j} \leq {T}_{bM} \}} ) ] - {E}_{t} [ {\sum }_{i = 1}^{bM} exp ( - {\int }_{t}^{Ti} r ( s ) ds ) ( \frac{1}{b} {C}_{t} \frac{1}{n} S ( {T}_{i} ) ) ]$$

where M is the maturity in years, b is the number of premium payments per annum, and T_{bM}−T₀ is the time to expiry of the CDS; T₁−T₀, . . . , T_{bM}−T_{bM-1} are the premium payment dates; LDG is the fraction of principal lost at default; τⱼ represents the time of default by firm j, which follows a Cox process with constant default intensity λ adapted to r; r(s) is the short-term rate following a diffusion process; I_{{t≦τ≦T}_{_{bM}}_{}} an indicator function that takes a value of 1 if the condition in the subscript, i.e. default occurs before maturity, holds true and zero otherwise; and Eₜ is the expectation conditional on information up to time t taken under the risk-neutral probability Q (say); Cₜ is the premium per annum, or “coupon,” expressed in decimals.

DSXₜ may be recast in terms of a hypothetical firm with default risk that is representative of the CDS index constituents

$$\begin{matrix}{DSX}_{t} = LGD \cdot {v}_{0 , t , t} - \frac{1}{b} {C}_{t} \cdot {v}_{1 , t} & \\ where & \\ {v}_{0 , {T}_{A} , {T}_{B}} ≡ {E}_{{T}_{A}} [ exp ( - {\int }_{{T}_{A}}^{{τ}_{*}} r ( s ) ds ) ( {I}_{\{ {T}_{B} \leq {τ}_{*} \leq {T}_{bM} \}} ) ] , & \\ {v}_{1 , t} ≡ {\sum }_{i = 1}^{bM} {E}_{t} [ exp ( - {\int }_{t}^{{T}_{i}} r ( s ) ds ) \cdot {I}_{\{ {Surv}_{*} \_at \_Ti \}} ] & \end{matrix}$$

where τ_{*} is the random default time of a representative firm with default intensity parameter λ and 1_{{Surv}_{_{*—}}ₐₜ_{_}_{T}_{ᵢ}_{}} is 1 if the representative firm has survived up to time Tᵢ and 0 otherwise. The interpretation of V_{0,T}_{_{A}}_{,T}_{_{B}} is the expected present value at time T_{A} of receiving one dollar if the representative firm defaults between T_{B} and maturity T_{bM}. The interpretation of v_{1,t} is the expected present value at time t of receiving one dollar on each Tᵢ until the earlier of default or maturity, which can be interpreted as the price value of a basis point (PVBP) adjusted for default risk.

A forward CDS index spread is the premium at which a protection buyer buys protection on the CDS index starting at a future date. If a protection buyer enters, at time t, into a M-year forward CDS index to start at time T with annualized premium equal to Cₜ, then the value of the protection leg minus the premium leg at any time s, sε(t,T), is

$${DSX}_{s} ( t , T ) ≡ N ( s ) \cdot ( LGD \cdot {v}_{0 , s , T} - \frac{1}{b} {C}_{t} \cdot {v}_{1 , s} )$$

where N(s) denotes the outstanding notional at time s

$$N ( s ) = \frac{1}{n} S ( s ) , N ( t ) ≡ 1$$

A payer (receiver) CDS index option gives the option holder the right but not obligation to buy (sell) protection on the CDS index on a future date at a fixed spread K, i.e. the strike. If the option holder buys a payer at time t that matures at time T>t, the option holder is entitled to receive “front-end protection” upon exercise at maturity, which is equal to the value of any losses from default of one or more of the CDS index's constituents between t and T. Mathematically, if

D(t,T)≡Σⱼ₌₁ⁿI_{{τjε(t,T)}}

is the number of defaults in time interval (t,T) then the payout at time T of the front-end protection is

$${F}_{T} ≡ LGD \cdot \frac{1}{n} \cdot D ( t , T )$$

and the value of F_{T} at time s is

$${v}_{s}^{F} ≡ {E}_{s} [ exp ( - {\int }_{s}^{T} r ( u ) du ) \cdot {F}_{T} ] = LGD ( \frac{1}{n} D ( t , s ) P ( s , T ) + N ( s ) ( P ( s , T ) - {P}_{def} ( s , T ) ) )$$

where P(s,T) is the price at time s of a non-defaultable zero coupon bond expiring at time T and P_{def}(s,T) is the price at time s of a defaultable zero-coupon bonds expiring at time T with LGD=100% and default intensity λ. This gives rise to a loss-adjusted forward CDS index defined as DSXₛ^{L}(t,T)≡DSXₛ(t,T)+vₛ^{F}.

In some embodiments of the present invention, we assume that CDS index options are cash-settled such that the payout upon exercise is equal to the default risk-adjusted net present value of the difference between the option strike K and the fair market premium of the CDX index at option expiry. An equivalent assumption would be that one can enter a CDS index position with spread equal to the option strike at option expiry and that there exist CDS indexes and options thereon corresponding to a continuum of strikes.

If we define CDXₛ(T,M) as the value of Cₛ such that DSXₛ^{L}(t,T)=0, then

$$\begin{matrix}\frac{1}{b} {CDX}_{s} ( T , M ) = LDG \frac{{v}_{0 , s , T}}{{v}_{1 , s}} + \frac{{v}_{s}^{F}}{N ( s ) {v}_{1 , s}} & \\ and & \\ {DSX}_{s}^{L} ( t , T ) = \frac{1}{b} N ( s ) {v}_{1 , s} ( {CDX}_{s} ( T , M ) - {C}_{t} ) & \end{matrix}$$

We define the “survival contingent probability measure” \hat{Q}_{sc} such that

$$\frac{d {\hat{Q}}_{sc}}{dQ} {\vert}_{{F}_{T}^{r}} = exp ( - {\int }_{s}^{T} r ( u ) du ) \cdot \frac{N ( T ) \cdot {v}_{1 , T}}{N ( s ) \cdot {v}_{1 , s}}$$

where Q is the risk-neutral probability, F_{T}^{r} is the information set at time T generated by the short rate process r(s) and CDXₛ(T,M) is a martingale under \hat{Q}_{sc}.

The price of a payer with strike K expiring at T on a M-year CDS index is

SWₛ^{p}(K,T;M)≡N(s))v_{1,s}·Êₛ^{sc}[(CDX_{T}(T,M)−K)⁺], sε[t,T]

and the price of a receiver with strike K expiring at T on a M-year CDS index is

SWₛ^{r}(K,T;M)≡N(s)v_{1,s}·Êₛ^{sc}[(K−CDX_{T}(T,M))⁺], sε[t,T]

where Êₛ^{sc} is the expectation under measure \hat{Q}_{sc} conditional on information up to time s.

Once we assume that CDXₜ(T,M) is a geometric Brownian motion with constant volatility under the survival contingent measure, Black's formula (Black, Fisher, “The Pricing of Commodity Contracts,” Journal of Financial Economics 3, 167-179 (1976)) may be used to evaluate the payer and receiver prices

$$\begin{matrix} {SW}_{t}^{p} ( K , T ; M ) ≡ {v}_{1 , t} \cdot Z ( {CDX}_{t} ( T , M ) , T , K ; ( T - t ) {IV}^{2} ( K ) ) & \\ and & \\ {SW}_{t}^{r} ( K , T ; M ) ≡ {v}_{1 , t} \cdot \hat{Z} ( {CDX}_{t} ( T , M ) , T , K ; ( T - t ) {IV}^{2} ( K ) ) & \\ where & \\ \hat{Z} ( CDX , T , K ; ( T - t ) {IV}^{2} ( K ) ) ≡ Z ( CDX , T , K ; ( T - t ) {IV}^{2} ( K ) ) + K - CDX & \\ Z ( CDX , T , K ; V ) ≡ CDX \cdot Φ ( d ) - KΦ ( d - \sqrt{V} ) , \\ d = \frac{ln \frac{CDX}{K} + \frac{1}{2} V}{\sqrt{V}} & \end{matrix}$$

and IV(K) is the percentage implied volatility for strike K and Φ is the cumulative standard normal distribution function.

We assume that CDXₛ(T,M) follows a jump diffusion process with stochastic volatility

$$\frac{{dCDX}_{s} ( T , M )}{{CDX}_{s} ( T , M )} = - ( {\hat{E}}_{s}^{sc} ( exp ( j ( s ; T , M ) - 1 ) η ( s ) ) ds + σ ( s ; T , M ) \cdot {dW}^{sc} ( s ) + ( exp ( j ( s ; T , M ) - 1 ) {dN}^{sc} ( s ) , s ∈ [ t , T ]$$

where W^{sc}(s) is a multidimensional Brownian motion defined under \hat{Q}_{sc}; σ(s;T,M) is a diffusion component adapted to W^{sc}(s); N^{sc}(s) is a Cox process with intensity η(s) defined under \hat{Q}_{sc}; j(s;T,M) is the logarithmic jump size. Then, the realized variance of the logarithmic changes in the CDS index spread, also known as percentage variance, is

V_{M}(t,T)≡∫ₜ^{T}∥σ(s;T,M)∥²ds+∫ₜ^{T}j²(s;T,M)dN^{sc}(s)

and the realized variance of the arithmetic changes in the CDS index spread, also known as basis point variance, is

V_{M}^{bp}(t,T)≡∫ₜ^{T}CDXₛ²(T,M)∥σ(s;M)∥²ds+∫ₜ^{T}CDXₛ²(T,M)(exp(j(s;T,M))−1)²dN^{sc}(s)

A “forward credit variance agreement” is an agreement between two parties in which, at time t, counterparty A agrees to pay counterparty B the product of the credit variance realized over [t,T] times the defaultable-PVBP of the outstanding notional that prevails at time T, i.e. V_{M}(t,T)×N(T)v_{1,T}. The price to be paid by counterparty B is denoted as F_{var,M}(t,T) and can be valued as

$${F}_{var , M} ( t , T ) = 2 [ {\sum }_{i : {K}_{i} < {CDX}_{t} ( T , M )} \frac{{SW}_{t}^{r} ( {K}_{i} , T ; M )}{{K}_{i}^{2}} Δ {K}_{i} + {\sum }_{i : {K}_{i} \geq {CDX}_{t} ( T , M )} \frac{{SW}_{t}^{p} ( {K}_{i} , T ; M )}{{K}_{i}^{2}} Δ {K}_{i} ]$$

where ΔKᵢ=½(Kᵢ₊₁−Kᵢ₋₁) for i≧1, and ΔK₀=(K₁−K₀), ΔK_{Z}=(K_{Z}−K_{Z-1}) where K₀ and K_{Z} are the lowest and highest traded strikes.

A “credit variance swap agreement” is an agreement between two parties in which, at time t, counterparty A agrees to pay counterparty B at time T the amount

Var−Swap_{M}(t,T)≡V_{M}(t,T)×N(T)v_{1,T}−P_{var,M}(t,T)

where P_{var,M}(t,T) is a rate fixed at time t and the “credit variance swap rate” is the value of P_{var,M}(t,T) such that the value at t of Var-Swap_{M}(t,T) is equal to zero, that is

$${P}_{var , M} ( t , T ) = \frac{{F}_{var , M} ( t , T )}{P ( t , T )}$$

The “standardized credit variance swap agreement” is an agreement between two parties in which, at time t, counterparty A agrees to pay counterparty B at time T the amount

Var−Swap*_{M}(t,T)≡[V_{M}(t,T)−P*_{var,M}(t,T)]×N(T)v_{1,T}

where P*_{var,M}(t,T) is a rate fixed at time t and the “standardized credit variance swap rate” is the value P*_{var,M}(t,T) such that the value at t of Var−Swap*_{M}(t,T) is equal to zero, that is

$${P}_{var , M}^{*} ( t , T ) = \frac{{F}_{var , M} ( t , T )}{{v}_{1 , t}}$$

The Percentage C-VI, C-VI is defined as

### Continuous Case:

$$C - VI ( t , T , M ) ≡ 100 \times \sqrt{\begin{matrix}\frac{2}{{v}_{1 , t} ( T - t )} [ {\int }_{0}^{{CDX}_{r} ( T , M )} \frac{{SW}_{t}^{r} ( K , T ; M )}{{K}^{2}} dK + \\ {\int }_{{CDX}_{t} ( T , M )}^{∞} \frac{{SW}_{t}^{p} ( K , T ; M )}{{K}^{2}} dK ]\end{matrix}}$$

### Discrete Case:

$$C - VI ( t , T , M ) ≡ 100 \times \sqrt{\begin{matrix}\frac{2}{{v}_{1 , t} ( T - t )} [ {\sum }_{i : {K}_{i} < {CDX}_{t} ( T , M )} \frac{{SW}_{t}^{r} ( {K}_{i} , T ; M )}{{K}_{i}^{2}} Δ {K}_{i} + \\ {\sum }_{i : {K}_{i} \geq {CDX}_{t} ( T , M )} \frac{{SW}_{t}^{p} ( {K}_{i} , T ; M )}{{K}_{i}^{2}} Δ {K}_{i} ]\end{matrix}}$$

Discrete Case with Forward Adjustment:

$$C - VI ( t , T , M ) ≡ 100 \times \sqrt{\begin{matrix}\frac{1}{( T - t )} [ \frac{2}{{v}_{1 , t}} [ {\sum }_{i : Ki < {K}_{*}} \frac{{SW}_{t}^{r} ( {K}_{i} , T ; M )}{{K}_{i}^{2}} Δ {K}_{i} + \\ {\sum }_{i : Ki \geq {K}_{*}} \frac{{SW}_{t}^{p} ( {K}_{i} , T ; M )}{{K}_{i}^{2}} Δ {K}_{i} ] - {( \frac{{CDX}_{t} ( T , M ) - {K}_{*}}{{K}_{*}} )}^{2} ]\end{matrix}}$$

### (Equation “PCT_CVI”)

where the forward adjustment handles the case in which there is no option struck at the ATM forward spread and K* is the first available strike below the ATM forward spread CDXₜ(T,M) If the forward spread is not observable at time t, then CDXₜ(T,M) is the strike at which the difference between the put and call prices is smallest.
More generally, for any constant multiplier CM:

### Continuous Case:

$$C - VI ( t , T , M ) ≡ CM \times \sqrt{\begin{matrix}\frac{2}{{v}_{1 , t} ( T - t )} [ {\int }_{0}^{{CDX}_{t} ( T , M )} \frac{{SW}_{t}^{r} ( K , T ; M )}{{K}^{2}} dK + \\ {\int }_{{CDX}_{t} ( T , M )}^{∞} \frac{{SW}_{t}^{p} ( K , T ; M )}{{K}^{2}} dK ]\end{matrix}}$$

### Discrete Case:

$$C - VI ( t , T , M ) ≡ CM \times \sqrt{\begin{matrix}\frac{2}{{v}_{1 , t} ( T - t )} [ {\sum }_{i : {K}_{i} < {CDX}_{t} ( T , M )} \frac{{SW}_{t}^{r} ( {K}_{i} , T ; M )}{{K}_{i}^{2}} Δ {K}_{i} + \\ {\sum }_{i : {K}_{i} \geq {CDX}_{t} ( T , M )} \frac{{SW}_{t}^{p} ( {K}_{i} T ; M )}{{K}_{i}^{2}} Δ {K}_{i} ]\end{matrix}}$$

Discrete Case with Forward Adjustment:

$$C - VI ( t , T , M ) ≡ CM \times \sqrt{\begin{matrix}\frac{1}{( T - t )} [ \frac{2}{{v}_{1 , t}} [ {\sum }_{i : Ki < {K}_{*}} \frac{{SW}_{t}^{r} ( {K}_{i} , T ; M )}{{K}_{i}^{2}} Δ {K}_{i} + \\ {\sum }_{i : Ki \geq {K}_{*}} \frac{{SW}_{t}^{p} ( {K}_{i} , T ; M )}{{K}_{i}^{2}} Δ {K}_{i} ] - {( \frac{{CDX}_{t} ( T , M ) - {K}_{*}}{{K}_{*}} )}^{2} ]\end{matrix}}$$

The above contract designs and index formulas are also extended for options on a forward CDS Index with a later start date than the option (similarly, if futures were traded on the CDS Index, the analogous case would be a future that expires after the option expiry); for example:

$$C - VI ( t , T , {T}_{D} , M ) ≡ 100 \times \sqrt{\begin{matrix}\frac{1}{( T - t )} [ \frac{2}{{v}_{1 , t}} [ {\sum }_{i : Ki < {K}_{*}} \frac{{SW}_{t}^{r} ( {K}_{i} , T , {T}_{D} ; M )}{{K}_{i}^{2}} Δ {K}_{i} + \\ {\sum }_{i : Ki \geq {K}_{*}} \frac{{SW}_{t}^{p} ( {K}_{i} , T , {T}_{D} ; M )}{{K}_{i}^{2}} Δ {K}_{i} ] - {( \frac{{CDX}_{t} ( {T}_{D} , M ) - {K}_{*}}{{K}_{*}} )}^{2} ]\end{matrix}}$$

where T_{D} denotes a time of maturity of the forward CDS index underlying the options where T_{D}≧T, and the notation for the forward spread CDXₜ(T_{D},M) is used above to highlight its dependence on the start date, T_{D}.

A “BP forward credit variance agreement” is an agreement between two parties in which, at time t, counterparty A agrees to pay counterparty B the product of the basis point credit variance realized over [t,T] times the defaultable-PVBP of the outstanding notional that prevails at time T, i.e. V_{M}^{bp}(t,T)×N(T))v_{1,T}. The price to be paid by counterparty B is denoted as F_{var,M}^{bp}(t,T), which may be valued as

$${F}_{var , M}^{bp} ( t , T ) = 2 [ {\sum }_{i : {K}_{i} < {CDX}_{t} ( T , M )} {SW}_{t}^{r} ( {K}_{i} , T ; M ) Δ {K}_{i} + {\sum }_{i : {K}_{i} \geq {CDX}_{t} ( T , M )} {SW}_{t}^{p} ( {K}_{i} , T ; M ) Δ {K}_{i} ]$$

where ΔKᵢ=½(Kᵢ₊₁−Kᵢ₋₁) for i≧1, and ΔK₀=(K₁−K₀), ΔK_{Z}=(K_{Z}−K_{Z-1}) where K₀ and K_{Z} are the lowest and highest traded strikes.

A “BP credit variance swap agreement” is an agreement between two parties in which, at time t, counterparty A agrees to pay counterparty B time T the amount V_{var,M}^{bp}(t,T)×N(T)v_{1,T}−P_{var,M}^{bp}(t,T) where P_{var,M}^{bp}(t,T) is a rate fixed at time t and the “credit variance swap rate” is the value of P_{var,M}^{bp}(t,T) such that the value at t of V_{var,M}^{bp}(t,T)×N(T)v_{1,T}−P_{var,M}^{bp}(t,T) is equal to zero, that is

$${P}_{var , M}^{bp} ( t , T ) = \frac{{F}_{var , M}^{bp} ( t , T )}{P ( t , T )}$$

The “standardized BP credit variance swap agreement” is an agreement between two parties in which, at time t, counterparty A agrees to pay counterparty B time T the amount [V_{M}^{bp}(t,T)−P*_{var,M}^{bp}(t,T)]×N(T)v_{1,T} where P*_{var,M}^{bp}(t,T) is a rate fixed a time t and the “standardized BP credit variance swap rate” is the value of P*_{var,M}^{bp}(t,T) such that the value at t of [V_{M}^{bp}(t,T)−P*_{var,M}^{bp}(t,T)]×N (T)v_{1,T} is equal to zero, that is

$${P}_{var , M}^{* bp} ( t , T ) = \frac{{F}_{var , M}^{bp} ( t , T )}{{v}_{1 , t}}$$

The model-free valuation of the basis point contracts in the three preceding sections do not require ignoring the jump component of the loss-adjusted forward CDS index spread dynamics.

The basis point C-VI, C-VI^{bp}, is defined as

### Continuous Case:

$$C - {VI}^{bp} ( t , T , M ) ≡ {100}^{2} \times \sqrt{\frac{2}{{v}_{1 , t} ( T - t )} [ {\int }_{0}^{{CDX}_{t} ( T , m )} {SW}_{t}^{r} ( K , T ; M ) dK + {\int }_{{CDX}_{t} ( T , M )}^{∞} {SW}_{t}^{p} ( K , T ; M ) dK ]}$$

### Discrete Case:

$$C - {VI}^{bp} ( t , T , M ) ≡ {100}^{2} \times \sqrt{\frac{2}{{v}_{1 , t} ( T - t )} [ {\sum }_{i : {K}_{i} < {CDX}_{t} ( T , M )} {SW}_{t}^{r} ( {K}_{i} , T ; M ) Δ {K}_{i} + {\sum }_{i : {K}_{i} \geq {CDX}_{t} ( T , M )} {SW}_{t}^{p} ( {K}_{i} , T ; M ) Δ {K}_{i} ]}$$

Discrete Case with Forward Adjustment:

$$C - {VI}^{bp} ( t , T , M ) ≡ {100}^{2} \times \sqrt{\frac{1}{( T - t )} [ \frac{2}{{v}_{1 , t}} [ {\sum }_{i : {K}_{i} < {K}_{*}} {SW}_{t}^{r} ( {K}_{i} , T ; M ) Δ {K}_{i} + {\sum }_{i : {K}_{i} \geq {K}_{*}} {SW}_{t}^{p} ( {K}_{i} , T ; M ) Δ {K}_{i} ] - {( {CDX}_{t} ( T , M ) - {K}_{*} )}^{2} ]} \qquad ( {Equation }^{“} {BP\_CVI}^{”} )$$

where the forward adjustment handles the case in which there is no option struck at the ATM forward spread and K_{*} is the first available strike below the ATM forward spread CDXₜ(T,M). If the forward spread is not observable at time t, then CDXₜ(T,M) is the strike at which the difference between the put and call prices is smallest.
More generally, for any constant multiplier CM:

### Continuous Case:

$$C - {VI}^{bp} ( t , T , M ) ≡ CM \times \sqrt{\frac{2}{{v}_{1 , t} ( T - t )} [ {\int }_{0}^{{CDX}_{t} ( T , M )} {SW}_{t}^{r} ( K , T ; M ) dK + {\int }_{{CDX}_{t} ( T , M )}^{∞} {SW}_{t}^{p} ( K , T ; M ) dK ]}$$

### Discrete Case:

$$C - {VI}^{bp} ( t , T , M ) ≡ CM \times \sqrt{\frac{2}{{v}_{1 , t} ( T - t )} [ {\sum }_{i : {K}_{i} < {CDX}_{t} ( T , M )} {SW}_{t}^{r} ( {K}_{i} , T ; M ) Δ {K}_{i} + {\sum }_{i : {K}_{i} \geq {CDX}_{t} ( T , M )} {SW}_{t}^{p} ( {K}_{i} , T ; M ) Δ {K}_{i} ]}$$

Discrete Case with Forward Adjustment:

$$C - {VI}^{bp} ( t , T , M ) ≡ CM \times \sqrt{\frac{1}{( T - t )} [ \frac{2}{{v}_{1 , t}} [ {\sum }_{i : {K}_{i} < {K}_{*}} {SW}_{t}^{r} ( {K}_{i} , T ; M ) Δ {K}_{i} + {\sum }_{i : {K}_{i} \geq {K}_{*}} {SW}_{t}^{p} ( {K}_{i} , T ; M ) Δ {K}_{i} ] - {( {CDX}_{t} ( T , M ) - {K}_{*} )}^{2} ]}$$

The above contract designs and index formulas are also extended for options on a forward CDS Index with a later start date than the option (similarly, if futures were traded on the CDS Index, the analogous case would be a future that expires after the option expiry); for example:

$$C - {VI}^{bp} ( t , T , {T}_{D} , M ) ≡ {100}^{2} \times \sqrt{\frac{1}{( T - t )} [ \frac{2}{{v}_{1 , t}} [ {\sum }_{i : {K}_{i} < {K}_{*}} {SW}_{t}^{r} ( {K}_{i} , T , {T}_{D} ; M ) Δ {K}_{i} + {\sum }_{i : {K}_{i} \geq {K}_{*}} {SW}_{t}^{p} ( {K}_{i} , T , {T}_{D} ; M ) Δ {K}_{i} ] - {( {CDX}_{t} ( {T}_{D} , M ) - {K}_{*} )}^{2} ]}$$

where T_{D} denotes a time of maturity of the CDS Index forward underlying the options where T_{D}≧T, and the notation for the forward spread CDXₜ(T_{D}, M) is used above to highlight its dependence on the start date, T_{D}.

In other embodiments of the present invention, we assume that CDS index options are settled such that upon exercise the option holder enters a CDS index position with a fixed premium that may differ from the option strike.

We consider indexes with fixed coupons Cₜ, such that at origination, the index value, DSXₜ, is

$${DSX}_{t} ≡ LGD \cdot {v}_{0 , t} - \frac{1}{b} {C}_{t} \cdot {v}_{1 , t}$$

The index spread is defined as the value of the coupon Cₜ that makes DSXₜ=0, i.e.,

$${S}_{t} ≡ LGD \frac{{v}_{0 t}}{\frac{1}{b} {v}_{1 t}} ,$$

such that the index value can be written as

$${DSX}_{t} = \frac{1}{b} ( {S}_{t} - {C}_{t} ) {v}_{1 t} .$$

We now evaluate v₀ₜ and v₁ₜ based on the assumption that the short-term rate and the hazard rate are both constant and equal to r and λ, respectively. Under this assumption, the expressions for v_{0,τ,T} and v_{1τ} collapse to

$$\begin{matrix}{v}_{0 , τ , T} ( λ ) = {e}^{- ( r + λ ) ( T - τ ) \frac{λ}{λ + r}} ( 1 - {e}^{- ( λ + r ) M} ) , & \\ {v}_{1 τ} ( λ ) = {e}^{- ( r + λ ) ( T - τ ) \frac{{e}^{- \frac{1}{b} ( λ + r )}}{1 - {e}^{- \frac{1}{b} ( λ + r )}}} ( 1 - {e}^{- ( λ + r ) M} ) , & \end{matrix}$$

where we are emphasizing that both v_{0,τ,T} and v_{1τ} are functions of λ, and where we recall that v₀ₜ≡V_{0,t,t}; accordingly, v₀ₜ(λ)≡v_{0,t,t}(λ).

Expressed as a function of λ, the index value is

$${DXS}_{t} ( λ ) = LGD \cdot {v}_{0 t} ( λ ) - {C}_{t} \frac{1}{b} {v}_{1 t} ( λ ) .$$

Assuming that LGD is large enough, there exists a positive λ̅ such that DSXₜ(λ̅)=DSXₜ^{$}, where DSXₜ^{$} denotes the index market value. In terms of λ̅, the index spread is

$${\overline{S}}_{t} ≡ {s}_{t} ( \overline{λ} ) ≡ LGD \frac{{v}_{0 t} ( \overline{λ} )}{\frac{1}{b} {v}_{1 t} ( \overline{λ} )} ,$$

which is referred to as the quoted spread or flat spread. Alternatively, note that one can define λ̅ as the number that yields the flat spread S̅ₜ through the equation

$${\overline{S}}_{t} ≡ {s}_{t} ( \overline{λ} ) ≡ LGD \frac{{v}_{0 t} ( \overline{λ} )}{\frac{1}{b} {{v}_{1 t} ( \overline{λ} )}^{′}} .$$

That is, define the mapping Sₜ [symbol] λ=sₜ⁻¹ [Sₜ], where sₜ⁻¹[•] denotes the inverse function of sₜ(λ). Then, λ̅=sₜ⁻¹[S̅ₜ]. In terms of S̅ₜ, the equation

$${DSX}_{t} = \frac{1}{b} ( {\overline{S}}_{t} - {C}_{t} ) {v}_{1 t}$$

becomes

$${DSX}_{t} ( {\overline{S}}_{t} ) = \frac{1}{b} ( {\overline{S}}_{t} - {C}_{t} ) {v}_{1 t} ( {\overline{S}}_{t} ) ,$$

where, with a slight abuse in notation, we set

v₁ₜ(S̅ₜ)≡v₁ₜ(sₜ⁻¹[S̅ₜ]),

and the right hand side of this identity is obtained through

$${v}_{1 τ} ( λ ) = {e}^{- ( r + λ ) ( T - τ )} \frac{{e}^{- \frac{1}{b} ( λ + r )}}{1 - {e}^{- \frac{1}{b} ( λ + r )}} ( 1 - {e}^{- ( λ + r ) M} ) .$$

We refer to v₁ₜ(x) as the flat defaultable annuity for a spread level equal to x.

Consider the forward starting position at T in a CDS index initiated at t and with fixed coupons Cₜ, which at time τε[t,T] has the value

$${DSX}_{τ} ( t , T ) ≡ N ( τ ) ( LGD \cdot {v}_{0 , τ , T} - \frac{1}{b} {C}_{t} \cdot {v}_{1 , τ} )$$

Next, define the forward spread, Fw_{τ} as the coupon C_{τ} such that a forward starting position initiated at τ is zero. It is easy to verify that

$${Fw}_{τ} = LGD \frac{{v}_{0 , τ , T}}{\frac{1}{b} {v}_{1 τ}} , {Fw}_{T} ≡ {\overline{S}}_{T} ,$$

where S̅_{T} satisfies

$${\overline{S}}_{t} ≡ {s}_{t} ( \overline{λ} ) ≡ LGD \frac{{v}_{0 t} ( \overline{λ} )}{\frac{1}{b} {{v}_{1 t} ( \overline{λ} )}^{′}} .$$

We have

$${DSX}_{τ} ( t , T ) = \frac{1}{b} 𝒩 ( τ ) {v}_{1 τ} ( {Fw}_{τ} - {C}_{t} ) , τ ∈ [ t , T ] .$$

The holder of a payer option on an index is entitled to a front-end protection, leading to the definition of the loss-adjusted forward spread, CDX_{τ}(T,M) and the loss-adjusted forward starting index value, DSX_{τ}^{L}(t,T), which at the option expiry T is

$${DSX}_{τ}^{L} ( t , T ) = \frac{1}{b} 𝒩 ( T ) {v}_{1 T} ( {CDX}_{T} ( T , M ) - {C}_{t} ) .$$

Options to enter into a CDS index may be struck at spreads differing from the initial contractual coupon Cₜ. The contract then requires a strike adjustment proportional to the difference between some value K and the coupon Cₜ. Only when K=Cₜ would the option payoffs collapse to those considered in the previously described embodiments in which an option always settles into a CDS index with a premium equal to the option strike. The strike adjustment is contractually equal to

$$\frac{1}{b} {H}_{T} ( {C}_{t} , K ) ,$$

where

H_{T}(Cₜ,K)≡(K−Cₜ)v_{1T}(K),

and V_{1T}(K) denotes the flat defaultable annuity for spread level equal to K, i.e. v_{1T}(s_{T}⁻¹ [K]). The final payoff of, say, a payer option is

$${( {DSX}_{T}^{L} ( t , T ) - \frac{1}{b} {H}_{T} ( {C}_{t} , K ) )}^{+} .$$

The rationale behind the strike adjustment is that once the holder of a payer swaption exercises, he will be long the on-the-run index, and be compensated for the difference between the index value and the value of the non-traded index with spread K.

Accordingly, the payer and receiver prices that are counterparts to the previously described embodiment are:

$${SW}_{τ}^{p} ( 𝒦 ( {C}_{t} , K , T ) , T , M ) ≡ \frac{1}{b} 𝒩 ( τ ) {v}_{1 τ} {\hat{𝔼}}_{τ}^{sc} [ {( {CDX}_{T} ( T , M ) - 𝒦 ( {C}_{t} , K , T ) )}^{+} ] , \\ and \\ {SW}_{τ}^{r} ( 𝒦 ( {C}_{t} , K , T ) , T , M ) ≡ \frac{1}{b} 𝒩 ( τ ) {v}_{1 τ} {\hat{𝔼}}_{τ}^{sc} [ {( 𝒦 ( {C}_{t} , K , T ) - {CDX}_{T} ( T , M ) )}^{+} ] , \\ where \\ 𝒦 ( {C}_{t} , K , T ) ≡ {C}_{t} + \frac{K - {C}_{t}}{𝒩 ( T ) {v}_{1 T}} {v}_{1 T} ( K ) , \qquad$$

and v_{1T} denotes the value of defaultable annuity at T, i.e., not the flat defaultable annuity for the loss-adjusted forward spread at T, v_{1T}(CDX_{T}(T,M)).

Naturally, when K=Cₜ, one has that [symbol] (Cₜ,K,T)|_{K=C}_{ₜ}=K such that the two pricing equations above collapse to those in the previously described embodiment. However, when K≠Cₜ, we cannot rely on [symbol] (τ)v_{1τ} as a numéraire as we did in the previously described embodiment. The two pricing formulae above suggest indeed that swaptions can be thought of as options with a random strike, [symbol] (Cₜ,K,T).

We now explain two non-limitative approaches to pricing options that settle into CDS indexes with premiums potentially different from the option strike. The first is based on approximations that lead to a standard Black formula with modified strikes, and the second is based on a model that aims to explicitly take into account the previous “random” strikes.

The first approach involves approximating the prices of options with random strikes in the equations

$${SW}_{τ}^{p} ( 𝒦 ( {C}_{t} , K , T ) , T , M ) ≡ \frac{1}{b} 𝒩 ( τ ) {v}_{1 τ} {\hat{𝔼}}_{τ}^{sc} [ {( {CDX}_{T} ( T , M ) - 𝒦 ( {C}_{t} , K , T ) )}^{+} ] , \\ and \\ {SW}_{τ}^{r} ( 𝒦 ( {C}_{t} , K , T ) , T , M ) ≡ \frac{1}{b} 𝒩 ( τ ) {v}_{1 τ} {\hat{𝔼}}_{τ}^{sc} [ {( 𝒦 ( {C}_{t} , K , T ) - {CDX}_{T} ( T , M ) )}^{+} ] , \qquad$$

with ones struck at deterministic strikes. Namely, replace [symbol] (T)v_{1T} in the equation

$$𝒦 ( {C}_{t} , K , T ) ≡ {C}_{t} + \frac{K - {C}_{t}}{𝒩 ( T ) {v}_{1 T}} {v}_{1 T} ( K )$$

with its conditional expectation under \hat{Q}_{sc}, [symbol] ₜ^{sc}( [symbol] (T)v_{1T}). Then we have

$$𝒩 ( T ) {v}_{1 T} \approx {\hat{𝔼}}_{τ}^{sc} ( 𝒩 ( T ) {v}_{1 T} ) = \frac{𝒩 ( τ ) {v}_{1 τ}}{P ( τ , T )} ,$$

where the last equality follows by the assumption that r is constant, which leads to the following approximations to SWₜ^{p}(•) and SWₜ^{r}(•):

$${τ}_{p}^{} ( \hat{𝒦} ( {C}_{t} , K , T ) , T ; M ) ≡ \frac{1}{b} 𝒩 ( τ ) {v}_{1 τ} {\hat{𝔼}}_{τ}^{sc} [ {( {CDX}_{T} ( T , M ) - \hat{𝒦} ( {C}_{t} , K , T ) )}^{+} ] , \\ and \\ {τ}_{r}^{} ( \hat{𝒦} ( {C}_{t} , K , T ) , T ; M ) ≡ \frac{1}{b} 𝒩 ( τ ) {v}_{1 τ} {\hat{𝔼}}_{τ}^{sc} [ {( \hat{𝒦} ( {C}_{t} , K , T ) - {CDX}_{T} ( T , M ) )}^{+} ] , \\ where \\ \hat{𝒦} ( {C}_{t} , K , T ) ≡ {C}_{t} + ( K - {C}_{t} ) \frac{P ( τ , T ) {v}_{1 T} ( K )}{𝒩 ( τ ) {v}_{1 τ}} , \qquad$$

which we shall refer to as the “modified strike.”

Note that the above formulas based on modified strikes imply that if K=Cₜ, then [symbol] (Cₜ,K,T)|_{K=C}_{ₜ}=K such that the options can be evaluated through the Black pricer as in the previously described embodiments. For other strikes, Black pricers can still be used to approximate options values using strikes set equal to [symbol] (Cₜ,K,T).

Define “Black's modified skew” as the function [symbol] that makes the modified Black's formula equal to market price, viz

[symbol]

: [symbol] ₜ^{x}( [symbol] (Cₜ,K,T),T,M; [symbol] )=SWₜ^{X,$}( [symbol] (Cₜ,K,T),T,M),

where [symbol] ₜ^{x}( [symbol] (Cₜ,K,T),T,M; [symbol] ) denotes the Black's formula for a payer (x=p) or receiver (x=r) obtained using the modified strike [symbol] (Cₜ,K,T) and SWₜ^{x,$}( [symbol] (Cₜ,K,T),T,M) is the market price for the payer (x=p) or receiver (x=r) with strike [symbol] (Cₜ,K,T), where

$$𝒦 ( {C}_{t} , K , T ) ≡ {C}_{t} + \frac{K - {C}_{t}}{𝒩 ( T ) {v}_{1 T}} {v}_{1 T} ( K ) .$$

The second approach is based on the model of Pedersen (2003). Define X_{T} as the random variable satisfying the equation

$${X}_{T} \text{:} \frac{1}{b} ( {X}_{T} - {C}_{t} ) {v}_{1 T} ( {X}_{T} ) = {DSX}_{T}^{L} ( t , T ) ,$$

where v_{1T}(X_{T}) denotes the flat defaultable annuity for spread X_{T} as defined by v₁ₜ(S̅ₜ)≡v₁ₜ(sₜ⁻¹[S̅_{t]}) above and DSX_{T}^{L}(t,T) as defined by

$${DSX}_{T}^{L} ( t , T ) = \frac{1}{b} 𝒩 ( T ) {v}_{1 T} ( {CDX}_{T} ( T , M ) - {C}_{t} )$$

above. In terms of X_{T}, the price of a payer swaption can be written as:

$${\overline{SW}}_{τ}^{p} ( {H}_{T} ( {C}_{t} , K ) , T , M ) ≡ \frac{1}{b} P ( τ , T ) {\hat{𝔼}}_{τ}^{{Q}_{{F}^{T}}} [ {( ( {X}_{T} - {C}_{t} ) {v}_{1 T} ( {X}_{T} ) - {H}_{T} ( {C}_{t} , K ) )}^{+} ] ,$$

where [symbol] _{τ}^{Q}^{_{F}}^{T} denotes the expectation under the forward probability Q_{F}_{^{T}}. The forward probability is defined as:

$$\frac{{dQ}_{{F}^{T}}}{dQ} {\vert}_{{𝔽}_{T}^{r}} = \frac{{e}^{- {\int }_{t}^{T} r ( u ) du}}{P ( t , T )} ,$$

and collapses to the risk-neutral probability Q once interest rates are constant. We are assuming that interest rates are constant, but shall continue to reference the forward probability space to keep more generality.

Next, define the conditional expectation [symbol] _{τ}(T)≡b· [symbol] _{τ}^{Q}^{_{F}}^{T}(DSX_{T}^{L}(t,T)), and the at the money (ATM) strike as the strike Kₐₜₘ that equalizes payer and receiver swaptions. By the put-call parity, Kₐₜₘ satisfies

H_{T}(Cₜ,Kₐₜₘ)= [symbol] _{τ}(T)= [symbol] _{τ}^{Q}^{_{F}}^{T}[(X_{T}−Cₜ)v_{1T}(X_{T})],

where the second equality follows by the definition of X_{T}. We refer to [symbol] _{τ}(T) as the (annualized) ATM forward price. It is the time τ price for “delivery” of the forward starting index value at T and equals

$$\begin{matrix}{ℱ}_{τ} ( T ) = b \cdot {\hat{𝔼}}_{τ}^{{Q}_{{F}^{T}}} ( {DSX}_{T}^{L} ( t , T ) ) \\ = {\hat{𝔼}}_{τ}^{{Q}_{{F}^{T}}} [ 𝒩 ( T ) {v}_{1 T} ( {CDX}_{T} ( T , M ) - {C}_{t} ) ] \\ = \frac{1}{P ( τ , T )} 𝒩 ( τ ) {v}_{1 τ} {\hat{𝔼}}_{τ}^{sc} ( {CDX}_{T} ( T , M ) - {C}_{t} ) \\ = \frac{1}{P ( τ , T )} 𝒩 ( τ ) {v}_{1 τ} ( {CDX}_{τ} ( T , M ) - {C}_{t} ) \\ = \frac{1}{P ( τ , T )} [ 𝒩 ( τ ) {v}_{1 τ} ( {Fw}_{τ} - {C}_{t} ) + {bv}_{τ}^{F} ] ,\end{matrix}$$

where the second line follows by

$${DSX}_{T}^{L} ( t , T ) = \frac{1}{b} 𝒩 ( T ) {v}_{1 T} ( {CDX}_{T} ( T , M ) - {C}_{t} ) ,$$

the third by a change of probability, the fourth by the martingale property of CDX_{τ}(T,M) under \hat{Q}_{sc}, the fifth by the expression for Fw_{τ} in

$${Fw}_{τ} = LGD \frac{{v}_{0 , τ , T}}{\frac{1}{b} {v}_{1 τ}} ,$$

and by the expression of CDX_{τ}(T,M) in

$$\frac{1}{b} {CDX}_{s} ( T , M ) = LDG \frac{{v}_{0 , s , T}}{{v}_{1 , s}} + \frac{{v}_{s}^{F}}{N ( s ) {v}_{1 , s}} .$$

Note that the pricing equation above for payers holds for any distribution of X_{T} that satisfies H_{T}(Cₜ,Kₐₜₘ)= [symbol] _{τ}(T)= [symbol] _{τ}^{Q}^{_{F}}^{T}[(X_{T}−Cₜ)v_{1T}(X_{T})]. The key assumption underlying Pedersen's model is that under the forward probability,

X_{T}^{x}^{^{o}}≡X_{T}=Xₜexp(−½s²(T−t)+s\sqrt{T−t}ω),Xₜ≡x^{o},

where ω is a standard Gaussian variable and s is a constant volatility parameter.

Given a value for s, the initial condition x^{o} can be calibrated by solving the following nonlinear equation:

[symbol]

_{τ}(T)= [symbol] _{τ}^{Q}^{_{F}}^{T}[(X_{T}^{x}^{^{o}}−Cₜ)v_{1T}(X_{T}^{x}^{^{o}})].

Swaption payers and receivers can now be evaluated based on the value of x^{o} that matches the ATM forward price, \hat{x}^{o}. Their prices are:

$$\begin{matrix}{\overline{SW}}_{τ}^{p} ( {H}_{T} ( {C}_{t} , K ) , T , M ; {x}^{o} , s ) ≡ \frac{1}{b} P ( τ , T ) {\hat{𝔼}}_{τ}^{{Q}_{{F}^{T}}} [ {( ( {X}_{T}^{{\hat{x}}^{o}} - {C}_{t} ) {v}_{1 T} ( {X}_{T}^{{\hat{x}}^{o}} ) - {H}_{T} ( {C}_{t} , K ) )}^{+} ] , & \\ and & \\ {\overline{SW}}_{τ}^{r} ( {H}_{τ} ( {C}_{t} , K ) , T , M ; {x}^{o} , s ) ≡ \frac{1}{b} P ( τ , T ) {\hat{𝔼}}_{τ}^{{Q}_{{F}^{T}}} [ {( {H}_{T} ( {C}_{t} , K ) - ( {X}_{T}^{{\hat{x}}^{o}} - {C}_{t} ) {v}_{1 T} ( {X}_{T}^{{\hat{x}}^{o}} ) )}^{+} ] . & \end{matrix}$$

These prices can be determined once we are given an estimate of the volatility parameter, s. For example, one can estimate s through the historical volatility of the spread of the underlying index. Alternatively, one could solve for the values of s and x^{o} that match market prices, as proposed below.

Each of the two options pricing approaches above lead to an index calculation methodology that take as inputs prices of CDS index options that settle into CDS indexes with premiums that potentially differ from the option strikes. The resulting methodologies may be thought of as modifications to those in the previously described embodiments in which an option always settles into a CDS index with a premium equal to the option strike.

First we describe a modification to the previously described C-VI methodology based on the modified Black formula. We begin by taking each traded out-of-the-money (OTM) payers and receivers with strike and solve for corresponding points of the modified Black's skew [symbol] . A suitable interpolation, e.g. polynomial spline, between the resulting points of the modified Black's skew for any missing values for [symbol] (Cₜ,K,T) leads to a continuous curve

k [symbol] σₖ.

Now a modified C-VI may be calculated by plugging the resulting values of [symbol] ₜ^{x}( [symbol] ᵢ,T,M; [symbol] ), xε{r,p}, described above, into the index formulae in the previously described embodiments in which an option always settles into a CDS index with a premium equal to the option strike, i.e.

$$\begin{matrix}C - VI ( t , T , M ) ≡ & \\ 100 \sqrt{\begin{matrix}\frac{1}{T - t} \frac{2}{{v}_{1 , t}} ( ω ( {\hat{𝒦}}_{i} ) {t}_{r}^{} ( {\hat{𝒦}}_{i} , T , M ; ) Δ {\hat{𝒦}}_{i} + \\ ω ( {\hat{𝒦}}_{i} ) {t}_{p}^{} ( {\hat{𝒦}}_{i} , T , M ; ) Δ {\hat{𝒦}}_{i} ) ,\end{matrix}} & \\ where & \\ {\hat{𝒦}}^{*} \text{:} {t}_{r}^{} ( {\hat{𝒦}}^{*} , T , M ; ) = {t}_{p}^{} ( {\hat{𝒦}}^{*} , T , M ; ) , & \\ and & \\ ω ( {\hat{𝒦}}_{i} ) = \{ \begin{matrix}{\hat{𝒦}}_{i}^{- 2} , & for a percentage index \\ 1 , & for a basis point index\end{matrix} & \\ and , finally , & \\ {\hat{𝒦}}_{i} , = \hat{𝒦} ( {C}_{t} , {K}_{i} , T ) . & \end{matrix}$$

As a non-limitative example, the sequence of modified strikes [symbol] ᵢ can be such that the strike intervals are the same. The previous modified index formula can also be generalized to one in which the strike intervals are not necessarily centered at [symbol] *. In particular, let [symbol] ₀ denote the first strike in a given strike grid Δ [symbol] ᵢ that is below CDXₜ(T,M), where in case CDXₜ(T,M) is not observed, it is approximated by the strike price at which the absolute difference between the payer and receiver prices is smallest. Then, a more general index formula is

$$\begin{matrix}C - VI ( t , T , M ) ≡ \\ 100 \sqrt{\frac{1}{T - t} ( \begin{matrix}\begin{matrix}\frac{2}{{v}_{1 , t}} ( \frac{{t}_{r}^{} ( {\hat{𝒦}}_{i} , T , M ; )}{{\hat{𝒦}}_{i}^{2}} Δ {\hat{𝒦}}_{i} + \\ ( \frac{{t}_{p}^{} ( {\hat{𝒦}}_{i} , T , M ; )}{{\hat{𝒦}}_{i}^{2}} Δ {\hat{𝒦}}_{i} ) -\end{matrix} \\ {( \frac{{CDX}_{t} ( T , M ) - {\hat{𝒦}}_{0}}{{\hat{𝒦}}_{0}} )}^{2}\end{matrix} )} ,\end{matrix}$$

for a percentage index and

$$C - VI ( t , T , M ) ≡ 100 \sqrt{\frac{1}{T - t} ( \begin{matrix}\frac{2}{{v}_{1 , t}} ( {t}_{r}^{} ( {\hat{𝒦}}_{i} , T , M ; ) Δ {\hat{𝒦}}_{i} + \\ {t}_{p}^{} ( {\hat{𝒦}}_{i} , T , M ; ) Δ {\hat{𝒦}}_{i} ) - \\ {( {CDX}_{t} ( T , M ) - {\hat{𝒦}}_{0} )}^{2}\end{matrix} )}$$

for a basis point index.
Finally, the sequence of modified strikes [symbol] ᵢ can be such that each element of this sequence is a modified strike that corresponds to a traded strike.
The above index formulas are also extended for options on a forward CDS Index with a later start date than the option (similarly, if futures were traded on the CDS Index, the analogous case would be a future that expires after the option expiry); for example:

$$C - VI ( t , T , {T}_{D} , M ) ≡ 100 \sqrt{\frac{1}{T - t} ( \begin{matrix}\frac{2}{{v}_{1 , t}} ( \\ {t}_{p}^{} ( {\hat{𝒦}}_{i} , T , {T}_{D} , M ; ) Δ {\hat{𝒦}}_{i} ) - \\ {( {CDX}_{t} ( {T}_{D} , M ) - {\hat{𝒦}}_{0} )}^{2}\end{matrix} )}$$

(for a basis point index) where T_{D} denotes a time of maturity of the CDS Index forward underlying the options where T_{D}≧T, and the notation for the forward spread CDXₜ(T_{D},M) is used above to highlight its dependence on the start date, T_{D}.
Finally, the above index formulas are also extended to account for the outstanding notional at the time of the index evaluation, [symbol] (t); for example:

$$C - VI ( t , T , M ) ≡ 100 \sqrt{\frac{1}{T - t} ( \begin{matrix}\frac{2}{{v}_{1 , t} 𝒩 ( t )} ( {t}_{r}^{} ( {\hat{𝒦}}_{i} , T , M ; ) Δ {\hat{𝒦}}_{i} + \\ ( {\hat{𝒦}}_{i} , T , M ; ) Δ {\hat{𝒦}}_{i} ) - \\ {( {CDX}_{t} ( T , M ) - {\hat{𝒦}}_{0} )}^{2}\end{matrix}} )$$

for a basis point index.

Next, we describe a modified C-VI calculation methodology based on Pedersen's model. Define

H̅_{T}(Cₜ,K)≡(K−Cₜ)v_{1T}(X_{T}^{x}^{^{o}}) and h(Cₜ,K,T;x^{o})≡(K−Cₜ)v_{1T}(x^{o})

where H̅_{T}(Cₜ,K) is the hypothetical strike adjustment such that the swaption prices in this section collapse to the swaption prices in the previously described embodiments:

SWₛ^{p}(K,T;M)≡N(s)v_{1,s}·Êₛ^{sc}[(CDX_{T}(M)−K)⁺], sε[t,T]

and

SWₛ^{r}(K,T;M)≡N(s)v_{1,s}·Êₛ^{sc}[(K−CDX_{T}(M))⁺], sε[t,T]

and the function h(Cₜ,K,T;x^{o}) is an approximation to H̅_{T}(Cₜ,K) where the unknown spread at T, X_{T}^{x}^{^{o}}, is replaced with its time t expectation, x^{o}. We shall refer to h(Cₜ,K,T;x^{o}) as the modified strike adjustment.
We then have

$$\begin{matrix}{SW}_{t}^{p} ( K , T ; M ) = \frac{1}{b} P ( t , T ) {\hat{𝔼}}_{t}^{{Q}_{{F}^{T}}} [ {( ( {X}_{T}^{{x}^{o}} - {C}_{T} ) {v}_{1 T} ( {X}_{T}^{{x}^{o}} ) - {\overline{H}}_{T} ( {C}_{t} , K ) )}^{+} ] \\ \approx \frac{1}{b} P ( t , T ) {\hat{𝔼}}_{t}^{{Q}_{{F}^{T}}} [ {( ( {X}_{T}^{{x}^{o}} - {C}_{t} ) {V}_{1 T} ( {X}_{T}^{{x}^{o}} ) - h ( {C}_{t} , K , T ; {x}^{o} ) )}^{+} ] \\ = {\overline{SW}}_{t}^{p} ( h ( {C}_{t} , K , T ; {x}^{o} ) , T ; M ; {x}^{o} , s ) ,\end{matrix}$$

where S̅W̅ₜ^{p}(h(Cₜ,K,T;x^{o}),T;M;x^{o},s) is Pedersen's model price calculated with the modified strike adjustment h(Cₜ,K,T;x^{o}).
Next, for each option strike K, define the “Pedersen's implied initial condition” and the “Pedersen implied volatility,” i.e. the pair (x_{K}^{o},s_{K}), referred to as “Pedersen's modified skew” in the sequel, such that the annualized ATM forward price and the swaption prices are matched to their market counterparts, viz

$$( {x}_{K}^{o} , {s}_{K} ) \text{:}$$

$${ℱ}_{t} ( T ) = {\hat{𝔼}}_{t}^{{Q}_{{F}^{T}}} [ ( {X}_{T}^{{x}_{K}^{o}} - {C}_{t} ) {v}_{1 T} ( {X}_{T}^{{x}_{K}^{o}} ) ] \\ and \\ {\overline{SW}}_{t}^{p} ( h ( {C}_{t} , K , T ; {x}_{K}^{o} ) , T , M ; ( {x}_{K}^{o} , {s}_{K} ) ) = {SW}_{t}^{p , \$} ( 𝒦 ( {C}_{t} , K , T ) , T , M ) .$$

Similarly as in the case of the modified Black's skew, we interpolate the Pedersen's modified skew (x_{K}^{o},s_{K}) in correspondence of any missing values for K, obtaining two continuous curves

K [symbol] x_{K}^{o} and K [symbol] s_{K}.

The modified C-VI calculation methodology based on the Pedersen model then consists of calculating the credit volatility indexes using this mapping with values of S̅W̅ₜ^{x}(hᵢ^{o},T,M;x_{K}_{ᵢ}^{o},s_{K}_{ᵢ}), xε{r,p} plugged into the index formulae into the index formulae in the previously described embodiments in which an option always settles into a CDS index with a premium equal to the option strike, and where

hᵢ^{o}≡h(Cₜ,K,T;x_{K}_{ᵢ}^{o}).

### That is,

$$C - VI ( t , T , M ) ≡ 100 \sqrt{\frac{1}{T - t} \frac{2}{{v}_{1 , t}} ( \begin{matrix}{\sum }_{i : {K}_{i} \leq {K}^{*}} ω ( {K}_{i} ) {\overline{SW}}_{t}^{r} ( {h}_{i}^{o} , T , M ; {x}_{{K}_{i}}^{o} , {s}_{{K}_{i}} ) Δ {K}_{i} + \\ {\sum }_{i : {K}_{i} > {K}^{*}} ω ( {K}_{i} ) {\overline{SW}}_{t}^{p} ( {h}_{i}^{o} , T , M ; {x}_{{K}_{i}}^{o} , {s}_{{K}_{i}} ) Δ {K}_{i}\end{matrix} )} , \\ where$$

$$K \text{:} {\overline{SW}}_{t}^{r} ( {h}_{*}^{o} , t , M ; {x}_{{h}_{*}^{o}}^{o} , {s}_{{h}_{*}^{o}} ) = {\overline{SW}}_{t}^{p} ( {h}_{*}^{o} , T , M ; {x}_{{h}_{*}^{o}}^{o} , {s}_{{h}_{*}^{o}} ) , \\ {h}_{*}^{o} ≡ h ( {C}_{t} , {K}^{*} , T ; {x}_{{K}^{*}}^{o} )$$

$$and$$

$$ω ( K ) = \{ \begin{matrix}{K}^{- 2} , & for a percentage index \\ 1 , & for a basis point index\end{matrix}$$

As a non-limitative example, the sequence of modified strike adjustments hᵢ can be such that the strike adjustment intervals are the same. The above index formula can also be generalized to one in which the strike intervals are not necessarily centered at K*. In particular, let K_{$} denote the first strike in a given strike grid ΔKᵢ that is below CDXₜ(T,M), where in case CDXₜ(T,M) is not observed, it is approximated by the strike price at which the absolute difference between the payer and receiver prices is smallest. Then, a generalized index formula is:

$$C - VI ( t , T , M ) ≡ 100 \sqrt{\frac{1}{T - t} ( \begin{matrix}\frac{2}{{v}_{1 , t}} ( \begin{matrix}{\sum }_{i : {K}_{i} \leq {CDX}_{t} ( T , M )} \frac{{\overline{SW}}_{t}^{r} ( {h}_{i}^{o} , T , M ; {x}_{{K}_{i}}^{o} , {s}_{{K}_{i}} )}{{K}_{i}^{2}} Δ {K}_{i} + \\ {\sum }_{i : {K}_{i} > {CDX}_{t} ( T , M )} \frac{{\overline{SW}}_{t}^{p} ( {h}_{i}^{o} , T , M ; {x}_{{K}_{i}}^{o} , {s}_{{K}_{i}} )}{{K}_{i}^{2}} Δ {K}_{i}\end{matrix} ) - \\ {( \frac{{CDX}_{t} ( T , M ) - {K}_{\$}}{{K}_{\$}} )}^{2}\end{matrix} )} ,$$

for a percentage index and

$$C - VI ( t , T , M ) ≡ 100 \sqrt{\frac{1}{T - t} ( \begin{matrix}\frac{2}{{v}_{1 , t}} ( \begin{matrix}{\sum }_{i : {K}_{i} \leq {CDX}_{t} ( T , M )} {\overline{SW}}_{t}^{r} ( {h}_{i}^{o} , T , M ; {x}_{{K}_{i}}^{o} , {s}_{{K}_{i}} ) Δ {K}_{i} + \\ {\sum }_{i : {K}_{i} > {CDX}_{t} ( T , M )} {\overline{SW}}_{t}^{p} ( {h}_{i}^{o} , T , M ; {x}_{{K}_{i}}^{o} , {s}_{{K}_{i}} ) Δ {K}_{i}\end{matrix} ) - \\ {( {CDX}_{t} ( T , M ) - {K}_{\$} )}^{2}\end{matrix} )} ,$$

for a basis point index.
Finally, the sequence of strikes Kᵢ may correspond to the sequence of traded strikes.
The above index formulas are also extended for options on a forward CDS Index with a later start date than the option (similarly, if futures were traded on the CDS Index, the analogous case would be a future that expires after the option expiry); for example:

$$C - VI ( t , T , {T}_{D} , M ) ≡ 100 \sqrt{\frac{1}{T - t} ( \begin{matrix}\frac{2}{{v}_{1 , t}} ( \begin{matrix}{\sum }_{i : {K}_{i} \leq {CDX}_{t} ( T , M )} {\overline{SW}}_{t}^{r} ( \begin{matrix}{h}_{i}^{o} , T , {T}_{D} , M ; \\ {x}_{{K}_{i}}^{o} , {s}_{{K}_{i}}\end{matrix} ) Δ {K}_{i} + \\ {\sum }_{i : {K}_{i} > {CDX}_{t} ( T , M )} {\overline{SW}}_{t}^{p} ( \begin{matrix}{h}_{i}^{o} , T , {T}_{D} , M ; \\ {x}_{{K}_{i}}^{o} , {s}_{{K}_{i}}\end{matrix} ) Δ {K}_{i}\end{matrix} ) - \\ {( {CDX}_{t} ( {T}_{D} , M ) - {K}_{\$} )}^{2}\end{matrix} )} ,$$

(for a basis point index) where T_{D} denotes a time of maturity of the CDS Index forward underlying the options where T_{D}≧T, and the notation for the forward spread CDXₜ(T_{D},M) is used above to highlight its dependence on the start date, T_{D}.
Finally, the above index formulas are also extended to account for the outstanding notional at the time of the index evaluation, [symbol] T(t); for example:

$$C - VI ( t , T , M ) ≡ 100 \sqrt{\frac{1}{T - t} ( \begin{matrix}\frac{2}{{v}_{1 , t} 𝒩 ( t )} ( \begin{matrix}{\sum }_{i : {K}_{i} \leq {CDX}_{t} ( T , M )} {\overline{SW}}_{t}^{r} ( \begin{matrix}{h}_{i}^{o} , T , M ; \\ {x}_{{K}_{i}}^{o} , {s}_{{K}_{i}}\end{matrix} ) Δ {K}_{i} + \\ {\sum }_{i : {K}_{i} > {CDX}_{t} ( T , M )} {\overline{SW}}_{t}^{p} ( \begin{matrix}{h}_{i}^{o} , T , M ; \\ {x}_{{K}_{i}}^{o} , {s}_{{K}_{i}}\end{matrix} ) Δ {K}_{i}\end{matrix} ) - \\ {( {CDX}_{t} ( T , M ) - {K}_{\$} )}^{2}\end{matrix} )} ,$$

for a basis point index.

The Black and Pedersen model-based modifications for calculating C-VIs have been given above for the case in which available as inputs are prices of options to enter into a CDS index that may be struck at spreads differing from the initial contractual coupon Cₜ. However, such options may be used directly with the C-VI formulas PCT_CVI and BP_CVI without any modifications. This may be done, for example, when the numerical impact of ignoring the modification steps are deemed ecnomically insignificant.

The mathematical exposition and formulas given above for Credit Volatility Indexes employ prices of European-style options on forward spreads. However, options with other exercise styles or options with other underlying spreads, such as futures spreads, may also be used directly in the above formulas if it is determined that the prices of such options are not materially different from equivalent prices of European-style options on forward spreads. For example, prices of out-of-the-money American-style options on a futures spread are likely to not be materially different from otherwise-equivalent European-style options on a forward spread, as one may conclude from the work of Flesaker, B. 1993, “Testing the Heath-Jarrow-Morton/Ho-Lee Model of Interest Rate Contingent Claims Pricing” Journal of Financial and Quantitative Analysis 28: pp. 483-495.

In the case that prices of available options that are not European-style on CDS index forward spreads may be materially different from those of European-style options on CDS index forward spreads, then a price adjustment may be made. For example, one may specify a market model [e.g. Brace, Gatarek and Musiela (1997), Jamshidian (1997), Miltersen, Sandmann and Sondermann (1997)] for the dynamics of the CDS index forward spreads, which leads to (i) an analytical solution for the European-style options on forwards based on Black's (1976) formula, and (ii) a numerical solution for the American-style options on futures. Then, one can calibrate an American Black's volatility for each future strike and exactly match the option price in (ii) to the market price for each strike, and use these calibrated American Black's volatilities to calculate the value of the European-style options in (i), which are then used to feed the index. This calibration procedure is a generalization of that implemented by Broadie, Chernov and Johannes (2007) in the equity case, and in regard of at-the-money American options. The forward spread is estimated through the value of the future spread, and if the future spread is not available, one can use the future strike at which the difference between the American put and call prices is smallest.

The methodology for computing Percentage and Basis Point C-VIs for forward CDS index spread volatility based on CDS index options can also be used to calculate Percentage and Basis Point C-VIs for forward single-name CDS spread volatility based on CDS options, simply by setting n=1 throughout the exposition.

For CDS index option markets that trade in cycles based on standardized roll dates (e.g. quarterly rolls in March, June, September, December), two or more options with varying maturities may be used in combination to calculate an index with a maturity corresponding to any maturity in between the shortest and longest maturities used.

In the case where CDS index options trade with maturity cycles, as a first non-limiting example, the index may be calculated with the nearest and next roll dates using a “sandwich combination” such that a volatility index with an m month horizon is calculated as

$${I}_{t} ≡ \sqrt{\frac{1}{( m / 12 )} [ {x}_{t} {V}_{t} ( {T}_{i} ) + ( 1 - {x}_{t} ) {V}_{t} ( {T}_{i + 1} ) ]} , t ∈ [ {T}_{i - 1} , {T}_{i} ]$$

where Tᵢ−Tᵢ₋₁=Tᵢ₊₁−Tᵢ=m×d and Tᵢ₊₁−Tᵢ₋₁=2m×d; d is the number of days in a month; Vₜ(Tᵢ) is equal to the square of one of the C-VI formulas described above; and xₜ is the weight such that

$${x}_{t} \frac{{T}_{i} - t}{12 d} + ( 1 - {x}_{t} ) \frac{{T}_{i + 1} - t}{12 d} = \frac{m}{12} , t ∈ [ {T}_{i - 1} , {T}_{i} ]$$

which leads to the expression

$${I}_{t} ≡ \sqrt{\frac{1}{( m / 12 )} [ ( \frac{{T}_{i + 1} - t}{m \times d} - 1 ) {V}_{t} ( {T}_{i} ) + ( 2 - \frac{{T}_{i + 1} - t}{m \times d} ) {V}_{t} ( {T}_{i + 1} )} , \\ t ∈ [ {T}_{i - 1} , {T}_{i} ]$$

In the case where CDS Index options trade with maturity cycles, as a second non-limiting example, the volatility index may be calculated based on the skew of a particular option contract with a shrinking time to maturity. For example, if the index is based on options expiring in three months on a 5-year index, the index on the first day would reflect expected volatility over the next three months, on the next day would reflect expected volatility over the next three months minus one day, and so on, until the index naturally expires at option expiry in three months.

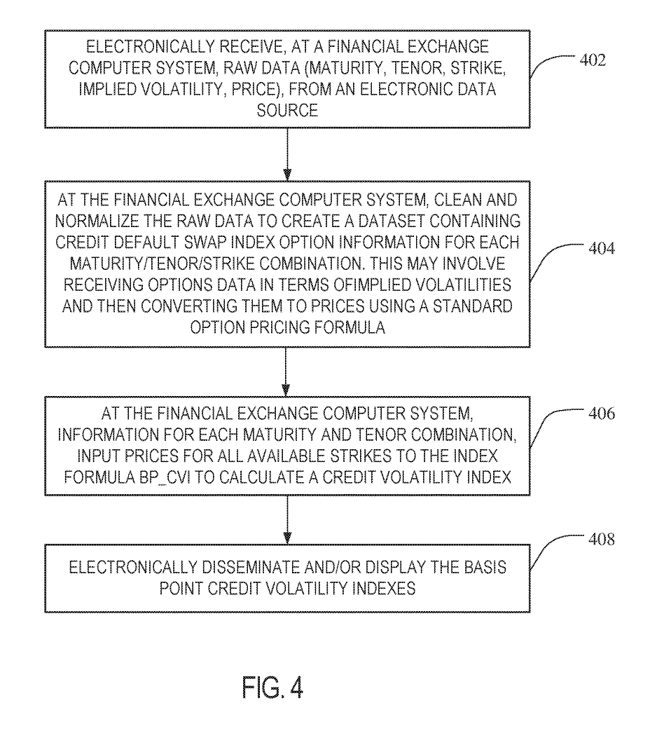

FIG. 4, is a flow diagram that outlines an embodiment of the steps for calculating and disseminating a basis point C-VI according to the present invention. At step 402, data is received electronically from an electronic data source. Included in the received data is data regarding the CDS index options. At step 404, the data is cleaned and normalized, according to known techniques. At step 406, the prices for each maturity and tenor combination for all available strikes are inputted into equation BP_CVI, shown above, to calculate a basis point C-VI. At step 408, the basis point credit volatility indexes may then be electronically disseminated and/or displayed.

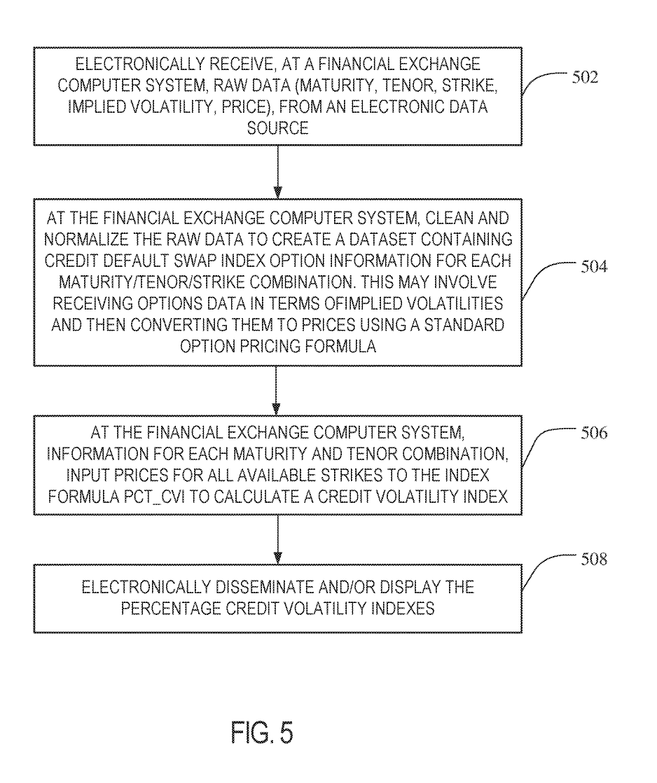

FIG. 5, is a flow diagram that outlines an embodiment of the steps for calculating and disseminating a percentage C-VI according to the present invention. At step 502, data is received electronically from an electronic data source. Included in the received data is data regarding the CDS index options. At step 504, the data is cleaned and normalized, according to known techniques. At step 506, the prices for each maturity and tenor combination for all available strikes are inputted into equation PCT_CVI, shown above, to calculate a percentage credit volatility index. At step 508, the percentage credit volatility indexes may then be electronically disseminated and/or displayed.

The steps shown in FIGS. 4 and 5 can be performed using the systems illustrated in FIGS. 2, 3, and 6.

### Implementation Examples

The following is a non-limiting example of how the methodologies of the present invention can be used to construct the Basis Point C-VI and the Percentage C-VI according to some embodiments of the present invention in which an option always settles into a CDS index with a premium equal to the option strike.

As noted above the actual calculation and dissemination of any of the C-VI is described herein are performed by the calculation and dissemination system, an example of which is illustrated in FIGS. 4 and 5.

The present example utilizes data reflecting hypothetical market prices. The data provided are implied volatilities expressed in percentage terms, and relate to CDS index options maturing in two months and tenor equal to five years. The data for this example is provided below in table 1:

TABLE 1

| | | Black's prices | |
|---|---|---|---|
| Strike | Percentage | Receiver | Payer |
| (in basis points) | Implied Vol | Swaption (\hat{Z}) | Swaption Z |
| 80 | 48.00 | 6.7430 · 10⁻³ | 2.5674 · 10⁻³ |
| 85 | 47.50 | 0.1279 · 10⁻³ | 2.1279 · 10⁻³ |
| 90 | 49.50 | 0.2512 · 10⁻³ | 1.7512 · 10⁻³ |
| 95 | 50.50 | 0.4151 · 10⁻³ | 1.4154 · 10⁻³ |
| 100 | 54.00 | 0.6714 · 10⁻³ | 1.1714 · 10⁻³ |
| 105 (ATM) | 55.00 | 0.9385 · 10⁻³ | 0.9385 · 10⁻³ |
| 110 | 56.00 | 1.2484 · 10⁻³ | 0.7484 · 10⁻³ |
| 115 | 57.50 | 1.6035 · 10⁻³ | 0.6035 · 10⁻³ |
| 120 | 59.50 | 1.9967 · 10⁻³ | 0.4967 · 10⁻³ |
| 125 | 61.50 | 2.4130 · 10⁻³ | 0.4130 · 10⁻³ |
| 130 | 62.50 | 2.8339 · 10⁻³ | 0.3339 · 10⁻³ |
| 135 | 63.50 | 3.2710 · 10⁻³ | 0.2710 · 10⁻³ |
| 140 | 65.50 | 3.7319 · 10⁻³ | 0.2319 · 10⁻³ |
| 145 | 66.50 | 4.1910 · 10⁻³ | 0.1910 · 10⁻³ |

The first two columns of Table 1, as shown above, report strike rates, K, and percentage implied volatilities for each strike rate, IV(K).

According to some embodiments of the present invention, the Basis Point C-VI and Percentage C-VI are calculated by first, plugging the “skew” IV(K) into the Black's formula, and then, replacing the Black's formula into the formulas shown above for calculating the Basis Point C-VI and Percentage C-VI, i.e., equations BP_CVI and PCT_CVI. Accordingly:

$$\begin{matrix} ( Equation “ PCT\_CVI \_IV ” ) \\ C - VI ( t , T , M ) = 100 \times \sqrt{\frac{1}{T - t} [ \begin{matrix}{\sum }_{i ; {K}_{i} < {CDX}_{t}} \frac{\hat{Z} ( \begin{matrix}{CDX}_{t} , T , {K}_{i} ; \\ ( T - t ) {IV}^{2} ( {K}_{i} )\end{matrix} )}{{K}_{i}^{2}} Δ {K}_{i} + \\ {\sum }_{i ; {K}_{i} \geq {CDX}_{t}} \frac{Z ( \begin{matrix}{CDX}_{t} , T , {K}_{i} ; \\ ( T - t ) {IV}^{2} ( {K}_{i} )\end{matrix} )}{{K}_{i}^{2}} Δ {K}_{i}\end{matrix} ]} , \\ and \\ ( Equation “ BP\_CVI \_IV ” ) \\ C - {VI}^{bp} ( t , T , M ) = {100}^{2} \times \sqrt{\frac{1}{T - t} [ \begin{matrix}{\sum }_{i ; {K}_{i} < {CDX}_{t}} \hat{Z} ( \begin{matrix}{CDX}_{t} , T , {K}_{i} ; \\ ( T - t ) {IV}^{2} ( {K}_{i} )\end{matrix} ) Δ {K}_{i} + \\ {\sum }_{i ; {K}_{i} \geq {CDX}_{t}} Z ( \begin{matrix}{CDX}_{t} , T , {K}_{i} ; \\ ( T - t ) {IV}^{2} ( {K}_{i} )\end{matrix} ) Δ {K}_{i}\end{matrix} ]} , \\ where \\ \hat{Z} ( CDX , T , {K}_{i} ; ( T - t ) {IV}^{2} ( {K}_{i} ) ) = Z ( CDX , T , {K}_{i} ; ( T - t ) {IV}^{2} ( {K}_{i} ) ) + K - CDX \\ Z ( CDX , T , K ; V ) = CDX \cdot Φ ( d ) - K Φ ( d - \sqrt{V} ) , d = \frac{ln \frac{CDX}{K} + \frac{1}{2} V}{\sqrt{V}}\end{matrix}$$

where Φ denotes the cumulative standard normal distribution.

According to the present example, the percentage implied volatilities, IV(K), are utilized to obtain values for \hat{Z} and Z. The third and fourth columns of Table 1, as shown above, provide CDS index option prices re-normalized by the defaultable PVBP, i.e., the values of \hat{Z} and Z, for each strike rate.

Table 2, as shown below, provides information regarding the present examples calculation of the Basis Point C-VI and Percentage C-VI, according to equations BP_CVI_IV and PCT_CVI_IV, respectively.

TABLE 2

| | | | Weights | | Contributions to Strikes | |
|---|---|---|---|---|---|---|
| Strike | Swaption | | Basis Point | Percentage | Basis Point | Percentage |
| (in basis points) | Type | Price | ΔKᵢ | ΔKᵢ/Kᵢ² | Contribution | Contribution |
| 80 | Receiver | 6.7430 · 10⁻³ | 0.0005 | 7.8125 | 3.3715 · 10⁻⁸ | 0.5268 · 10⁻³ |
| 85 | Receiver | 0.1279 · 10⁻³ | 0.0005 | 6.9204 | 6.3951 · 10⁻⁸ | 0.8851 · 10⁻³ |
| 90 | Receiver | 0.2512 · 10⁻³ | 0.0005 | 6.1728 | 1.2563 · 10⁻⁷ | 1.5510 · 10⁻³ |
| 95 | Receiver | 0.4151 · 10⁻³ | 0.0005 | 5.5401 | 2.0774 · 10⁻⁷ | 2.3018 · 10⁻³ |
| 10 | Receiver | 0.6714 · 10⁻³ | 0.0005 | 5.0000 | 3.3574 · 10⁻⁷ | 3.3574 · 10⁻³ |
| 105 | ATM | 0.9385 · 10⁻³ | 0.0005 | 4.5351 | 4.6929 · 10⁻⁷ | 4.2566 · 10⁻³ |
| 110 | Payer | 0.7484 · 10⁻³ | 0.0005 | 4.1322 | 3.7421 · 10⁻⁷ | 3.0926 · 10⁻³ |
| 115 | Payer | 0.6035 · 10⁻³ | 0.0005 | 3.7807 | 3.0179 · 10⁻⁷ | 2.2820 · 10⁻³ |
| 120 | Payer | 0.4967 · 10⁻³ | 0.0005 | 3.4722 | 2.4837 · 10⁻⁷ | 1.7248 · 10⁻³ |
| 125 | Payer | 0.4130 · 10⁻³ | 0.0005 | 3.2000 | 2.0651 · 10⁻⁷ | 1.3216 · 10⁻³ |
| 130 | Payer | 0.3339 · 10⁻³ | 0.0005 | 2.9585 | 1.6695 · 10⁻⁷ | 0.9879 · 10⁻³ |
| 135 | Payer | 0.2710 · 10⁻³ | 0.0005 | 2.7434 | 1.3551 · 10⁻⁷ | 0.7435 · 10⁻³ |
| 140 | Payer | 0.2319 · 10⁻³ | 0.0005 | 2.5510 | 1.1597 · 10⁻⁷ | 0.5917 · 10⁻³ |
| 145 | Payer | 0.1910 · 10⁻³ | 0.0005 | 2.3781 | 9.5530 · 10⁻⁸ | 0.4543 · 10⁻³ |
| | | | | SUMS | 2.8809 · 10⁻⁶ | 2.4077 · 10⁻² |

The second column of Table 2 displays the type of out-of the money CDS index option entering in the calculations of the embodiments of the C-VI. The third column has the price normalized by the risky PVBP corresponding to the used CDS index options; the fourth and fifth columns report the weights each Black's price bears towards the final computation of the index, before the final rescaling of

$$\frac{2}{T - t} ;$$

and finally, the sixth and seventh columns report each out-of-the money CDS index option price corrected by the appropriate weight. Each price in the third column is multiplied by the corresponding weight in the fourth column, for the “Basis Point Contribution,” and each price in the third column is multiplied by the corresponding weight in the fifth column, for the “Percentage Contribution.”

Thus, according to the data provided in this example, embodiments of the Basis Point C-VI and Percentage C-VI are calculated, respectively, as follows:

$$C - VI = 100 \times \sqrt{\frac{2}{( 2 / 12 )} \times 2.4077 \cdot {10}^{- 2}} = 53.7524 , and$$

$$C - {VI}^{bp} = {100}^{2} \times \sqrt{\frac{2}{( 2 / 12 )} \times 2.8809 \cdot {10}^{- 6}} = 58.7975 ,$$

For purposes of comparison, the at-the-money implied basis point and percentage volatilities are IV^{BP} (CDX)=57.75 bps and IV(CDX)=55%.

In this non-limiting example, the basis point index is rescaled by 100², to mimic the market practice to express basis point implied volatility as the product of rates times log-volatility, where both rates and log-volatility are multiplied by 100.

According to embodiments of the present invention, indices calculated according to the embodiments of the present invention may serve as the underlying asset for derivative contracts, such as options and futures contracts. More particularly, according to an embodiment of the present invention, a C-VI may serve as the underlying reference for derivative contracts designed for trading the volatility of forward CDS index spreads of various indexes and tenors. In particular, futures and options contracts with varying maturities based the index may be traded OTC and/or listed on exchanges.

Derivative instruments based on the credit default swap index option volatility index disclosed above may be created as standardized, exchange-traded contracts, as opposed to over-the-counter contracts. Once the credit default swap index option volatility index (C-VI) based on CDS index options is calculated, the index may be accessed for use in creating a derivative contract, and the derivative contract may be assigned a unique symbol. Generally, the C-VI derivative contract may be assigned any unique symbol that serves as a standard identifier for the type of standardized C-VI derivative contract. Information associated with the C-VI and/or the C-VI derivative contract may be transmitted for display, such as transmitting information to list the C-VI index and/or the C-VI derivative on a trading platform. Examples of the types of information that may be transmitted for display include a settlement price of a C-VI derivative, a bid or offer associated with a C-VI derivative, a value of a C-VI index, and/or a value of an underlying CDS index option that a C-VI is associated with.

Generally, a C-VI derivative contract may be listed on an electronic platform, an open outcry platform, a hybrid environment that combines the electronic platform and open outcry platform, or any other type of platform known in the art. One example of a hybrid exchange environment is disclosed in U.S. Pat. No. 7,613,650, filed Apr. 24, 2003, the entirety of which is herein incorporated by reference. Additionally, a trading platform such as an exchange may transmit C-VI derivative contract quotes of liquidity providers over dissemination networks to other market participants. Liquidity providers may include Designated Primary Market Makers (“DPM”), market makers, locals, specialists, trading privilege holders, registered traders, members, or any other entity that may provide a trading platform with a quote for a variance derivative. Dissemination Networks may include networks such as the Options Price Reporting Authority (“OPRA”), the CBOE Futures Network, an Internet website or email alerts via email communication networks. Market participants may include liquidity providers, brokerage firms, normal investors, or any other entity that subscribes to a dissemination network.

The trading platform may execute buy and sell orders for the C-VI derivative and may repeat the steps of calculating the C-VI of the underlying CDS index options, accessing the C-VI index, transmitting information for the C-VI index and/or the C-VI derivative for display (list the C-VI and/or C-VI derivative on a trading platform), disseminating the C-VI and/or the C-VI derivative over a dissemination network, and executing buy and sell orders for the C-VI derivative until the C-VI derivative contract is settled.

In some implementations, C-VI derivative contracts may be traded through an exchange-operated parimutuel auction and cash-settled based on the C-VI index of log returns of the underlying equity. An electronic parimutuel, or Dutch, auction system conducts periodic auctions, with all contracts that settle in-the-money funded by the premiums collected for those that settle out-of-the-money.

As mentioned, in a parimutuel auction, all the contracts that settle in-the-money are funded by those that settle out-of-the-money. Thus, the net exposure of the system is zero once the auction process is completed, and there is no accumulation of open interest over time. Additionally, the pricing of contracts in a parimutuel auction depends on relative demand; the more popular the strike, the greater its value. In other words, a parimutuel action does not depend on market makers to set a price; instead the price is continuously adjusted to reflect the stream of orders coming into the auction. Typically, as each order enters the system, it affects not only the price of the sought-after strike, but also affects all the other strikes available in that auction. In such a scenario, as the price rises for the more sought-after strikes, the system adjusts the prices downward for the less popular strikes. Further, the process does not require the matching of specific buy orders against specific sell orders, as in many traditional markets. Instead, all buy and sell orders enter a single pool of liquidity, and each order can provide liquidity for other orders at different strike prices and the liquidity is maintained such that system exposure remains zero. This format maximizes liquidity, a key feature when there is no tradable underlying instrument.

The following characteristics of futures contracts illustrate one embodiment of a futures contract having an index of the present invention as an underlying asset. The characteristics are not meant to limit the present invention, but rather to set forth common characteristics of futures:

Contract Size: The notional amount of one unit of the contract may be defined as a multiple of the index level, which may depend on the currency of the underlying index. When traded OTC, the multiplier may be negotiated between the parties involved on a trade-by-trade basis.

Contract Months: An exchange may list contracts with a pre-determined sequence of maturity dates, e.g. the 3rd Friday of each of the next 6 months. Similarly, OTC dealers may make markets in a pre-determined sequence of maturity dates but may also make markets for contracts that mature on other dates on a trade-by-trade basis.

Quotation & Minimum Price Intervals: Futures based on the index may be quoted in points and decimals or fractions that represent some notional amount per contract and there may be a minimum increment by which the pricing of the contracts may vary, both of which may depend on the currency of the underlying index. The OTC market may adopt different conventions for quoting and minimum ticks.

Last Trading Date: For each contract, a last trading date will be specified.

Final Settlement Date: For each contract, a final settlement date will be specified.

Final Settlement Value: The final settlement value shall be based on the level of the index computed at a pre-specified time on the settlement date.

Delivery: Settlement of futures based on the index will take the form of a delivery of the cash settlement amount and a payment date will be specified in relation to the final settlement date.

Additional Specifications when Exchange Traded: When traded on an exchange, trading platform, margin requirements, trading hours, order crossing rules, block trading rules, reporting rules, and other details may be specified.

The following characteristics of options contracts illustrate one embodiment of an options contract having an index of the present invention as an underlying asset. The characteristics are not meant to limit the present invention, but rather to set forth common characteristics of options:

Contract Size: The notional amount of one unit of the contract may be defined as a multiple of the index level, which may depend on the currency of the underlying index. When traded OTC, the multiplier may be negotiated between the parties involved on a trade-by-trade basis.

Contract Months: An exchange may list contracts with a pre-determined sequence of expiration dates, e.g. the 3rd Friday of each of the next 6 months. Similarly, OTC dealers may make markets in a pre-determined sequence of maturity dates but may also make markets for contracts that expire on other dates on a trade-by-trade basis.

Strike Prices: For each currency, strike prices that are in-, at-, and out-of the money may be listed by an exchange or quoted by OTC dealers and new strike prices may be traded as swap rates increase and decrease. An exchange or the OTC dealer community may fix a minimum increment between strike prices, depending on the currency of the underlying index.

Quotation & Minimum Price Intervals: Options based on the index may be quoted in points and decimals or fractions that represent some notional amount per contract and there may be a minimum increment by which the pricing of the contracts may vary, both of which may depend on the currency of the underlying index. The OTC Market may adopt different conventions for quoting and minimum ticks.

Exercise Style: Options written on the C-VI are likely to be, but not limited to, European style. It is envisioned that American style contracts could also have an index of the present invention as an underlying asset

Expiration Date: For each contract, an expiration date will be specified.

Last Trading Date: For each contract, a last trading date will be specified.

Settlement of Exercise: The final settlement value shall be based on the level of the index computed at a pre-specified time on the settlement date. The cash settlement amount will be the difference between the index level and the strike price, possibly adjusted by some multiplier, and a payment date will be specified in relation to the expiration date.

Additional Specifications when Exchange Traded: When traded on an exchange, trading platform, margin requirements, trading hours, reporting rules, and other details may be specified.

According to other embodiments of the present invention, other financial products that track or reference the indices of the present invention may be created. Such products include, but are not limited to, Exchange Traded Funds and Exchange Traded Notes listed on exchanges and structured products sold by financial institutions.

As has been described above, a system and method for addressing the problems of missing or incomplete data in maintaining index calculations, for example for credit volatility indexes, can help avoid or minimize system processing costs and inaccuracies that may otherwise crop up. In the context of a credit volatility index algorithm, the imperfections in system performance and accuracy may be because there may not be pricing data for some strikes that should be included as inputs to the algorithm calculation. The system and method described herein may utilize information on one input data change or a portion of the input data of the complete input data set that a particular index calculation would use to then estimate changes on some or all of the remaining input data for the complete data set. The system and method may use cached or archived data points, the last true data points for a particular constituent trade value, or may estimate new trade values for all missing data points in the complete data set.

The index generated based on the actual and/or estimated data points may be a credit volatility indexes and derivative instruments based thereon may be generated and disseminated. An advantage of derivatives based on the credit volatility indexes disclosed herein is the ability to provide a hedge against options or other derivatives that are subject to credit volatility risk. It is intended that the foregoing detailed description be regarded as illustrative rather than limiting, and that it be understood that it is the following claims, including all equivalents, that are intended to define the spirit and scope of this invention.

We claim:

1. A computer system for avoiding delays in updating an index calculation comprising:
memory configured to store at least one program; and
at least one processor communicatively coupled to the memory, in which the at least one program, when executed by the at least one processor, causes the at least one processor to:
receive new option trade data for one of a plurality of constituent options needed for a complete data set of option trade data utilized in a credit volatility index equation;
when an index refresh period has elapsed, wherein the index refresh period is a predetermined period of time for receiving new option trade data for the plurality of constituent options, and new option trade data for all of the plurality of constituent options has not been received:
utilize the received new option trade data for the one of the plurality of constituent options to generate respective estimated new option trade data for each of a remainder of the plurality of constituent options;
calculate, using the received new option trade data and the estimated new option trade data for the plurality of constituent options, a credit volatility index; and
transmit data regarding the credit volatility index,
wherein the credit volatility index is calculated at time t according to the equation:
$$C - VI ( t , T , M ) ≡ 100 \times \sqrt{\frac{1}{( T - t )} [ \begin{matrix}\frac{2}{{v}_{1 , t}} [ \begin{matrix}{\sum }_{i : Ki < {K}_{*}} \frac{{SW}_{t}^{r} ( {K}_{i} , T ; M )}{{K}_{i}^{2}} Δ {K}_{i} + \\ {\sum }_{i : Ki \geq {K}_{*}} \frac{{SW}_{t}^{p} ( {K}_{i} , T ; M )}{{K}_{i}^{2}} Δ {K}_{i}\end{matrix} ] - \\ {( \frac{{CDX}_{t} ( T , M ) - {K}_{*}}{{K}_{*}} )}^{2}\end{matrix} ]}$$
wherein:
t denotes a time at which the credit volatility index is calculated;
T denotes a time of expiry of options on credit default swap indexes;
M denotes a time of expiry of credits default swap indexes;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
ΔKᵢ=½(Kᵢ₊₁−Kᵢ₋₁) for i≧1, and ΔK₀=(K₁−K₀),ΔK_{Z}=(K_{Z}−K_{Z-1});
if the price is observable at time t, then CDXₜ(T,M) is a price at time t of a credit default swap index derivative, expiring at T, with an underlying credit default swap index maturing at M;
if the price is not observable at time t, then CDXₜ(T,M) is the spread at which the difference between the put and call prices is smallest;
if there exists an option struck at CDXₜ(T,M), then K_{*} equals CDXₜ(T,M);
if there does not exist an option struck at CDXₜ(T,M), then K_{*} is the first available strike below CDXₜ(T,M);
v_{1,t} is a price value of a basis point at time t, adjusted for default risk, of the credit default swap index premium payments;
SWₜ^{r}(Kᵢ,T;M) is a price at time t of a receiver option, struck at Kᵢ, expiring at T, and having an underlying credit default swap index derivative expiring at T with an underlying credit default swap index maturing at M;
SWₜ^{p}(Kᵢ,T;M) is a price at time t of a payer option, struck at Kᵢ, expiring at T, and having an underlying credit default swap index derivative expiring at T with an underlying credit default swap index maturing at M; and
C-VI(t,T,M) is the value of the credit volatility index at time t calculated based on options expiring at T on credit default swap index derivatives expiring at T with an underlying credit default swap index maturing at M.

2. The computer system of claim 1, wherein the new option trade data includes data regarding prices of options on credit default swap index derivatives.

3. The computer system of claim 2, wherein the data regarding prices of options on credit default swap index derivatives includes data regarding prices of European style options on credit default swap index forwards.

4. The computer system of claim 2, wherein the data regarding prices of options on credit default swap index derivatives includes data regarding prices of options that are not European style options on credit default swap index forwards.

5. The computer system of claim 4, wherein, when the data regarding prices of options on credit default swap derivatives includes data regarding prices of options that are not European-style options on credit default swap index forwards, converting the data regarding prices of options that are not European-style options on credit default swap index forwards to data regarding prices of European style options on credit default swap index forwards.

6. The computer system of claim 1, wherein calculating the credit volatility index includes valuing a basket of options on the credit default swap derivatives required for model-independent pricing of a variance swap contract on the credit default swap derivatives.

7. The computer system of claim 1, wherein the at least one processor is further caused to:
create a standardized exchange-traded derivative instrument based on the credit volatility index; and
transmit data regarding the standardized exchange-traded derivative.

8. The computer system of claim 7, wherein transmitting data regarding the standardized exchange-traded derivative instrument includes transmitting data regarding one or more of a settlement price, a bid price, an offer price, or a trade price of the standardized exchange-traded derivative instrument.

9. A method for avoiding delays in updating an index calculation in an exchange system, the method comprising:
receiving, at a trade processor of the exchange system, new option trade data for one of a plurality of constituent options forming a complete data set of option trade data utilized in a credit volatility index equation;
monitoring an index refresh period at the trade processor, wherein the index refresh period is a predetermined period of time for receiving new option trade data for the plurality of constituent options;
upon expiration of the index refresh period, and when no new option trade data for other than the one of the plurality of constituent options has been received during the index refresh period:
generate, based on the received new option trade data for the one of the plurality of constituent options, respective estimated new option trade data for each of the plurality of constituent options other than the one of the plurality of constituent options;
calculate, using the received new option trade data and the estimated new option trade data for the plurality of constituent options, a credit volatility index; and
transmit data regarding the credit volatility index,
wherein the credit volatility index is calculated at time t according to the equation:
$$C - VI ( t , T , M ) ≡ 100 \times \sqrt{\frac{1}{( T - t )} [ \begin{matrix}\frac{2}{{v}_{1 , t}} [ \begin{matrix}{\sum }_{i : Ki < {K}_{*}} \frac{{SW}_{t}^{r} ( {K}_{i} , T ; M )}{{K}_{i}^{2}} Δ {K}_{i} + \\ {\sum }_{i : Ki \geq {K}_{*}} \frac{{SW}_{t}^{p} ( {K}_{i} , T ; M )}{{K}_{i}^{2}} Δ {K}_{i}\end{matrix} ] - \\ {( \frac{{CDX}_{t} ( T , M ) - {K}_{*}}{{K}_{*}} )}^{2}\end{matrix} ]}$$
wherein:
t denotes a time at which the credit volatility index is calculated;
T denotes a time of expiry of options on credit default swap indexes;
M denotes a time of expiry of credit default swap indexes;
Z+1 denotes a total number of options used in the index calculation;
K₀ denotes the lowest strike of the Z+1 options;
Kᵢ denotes the i^{th} highest strike of the Z+1 options;
K_{Z} denotes the highest strike of the Z+1 options;
ΔKᵢ=½(Kᵢ₊₁−Kᵢ₋₁) for i≧1, and ΔK₀=(K₁−K₀),ΔK_{Z}=(K_{Z}−K_{Z-1});
if the price is observable at time t, then CDXₜ(T,M) is a price at time t of a credit default swap index derivative, expiring at T, with an underlying credit default swap index maturing at M;
if the price is not observable at time t, then CDXₜ(T,M) is the spread at which the difference between the put and call prices is smallest;
if there exists an option struck at CDXₜ(T,M), then K_{*} equals CDXₜ(T,M);
if there does not exist an option struck at CDXₜ(T,M), then K_{*} is the first available strike below CDXₜ(T,M);
v_{1,t} is a price value of a basis point at time t, adjusted for default risk, of the credit default swap index premium payments;
SWₜ^{r}(Kᵢ,T;M) is a price at time t of a receiver option, struck at Kᵢ, expiring at T, and having an underlying credit default swap index derivative expiring at T with an underlying credit default swap index maturing at M;
SWₜ^{p}(Kᵢ,T;M) is a price at time t of a payer option, struck at Kᵢ, expiring at T, and having an underlying credit default swap index derivative expiring at T with an underlying credit default swap index maturing at M; and
C-VI(t,T,M) is the value of the credit volatility index at time t calculated based on options expiring at T on credit default swap index derivatives expiring at T with an underlying credit default swap index maturing at M.

10. The method of claim 9, wherein the new option trade data includes data regarding prices of options on credit default swap index derivatives.

11. The method of claim 9, wherein the data regarding prices of options on credit default swap index derivatives includes data regarding prices of European style options on credit default swap index forwards.

12. The method of claim 9, wherein the data regarding prices of options on credit default swap index derivatives includes data regarding prices of options that are not European style options on credit default swap index forwards.

13. The method of claim 11, wherein, when the data regarding prices of options on credit default swap derivatives includes data regarding prices of options that are not European-style options on credit default swap index forwards, converting the data regarding prices of options that are not European-style options on credit default swap index forwards to data regarding prices of European style options on credit default swap index forwards.

14. The computer system of claim 1, wherein calculating the credit volatility index includes valuing a basket of options on the credit default swap derivatives required for model-independent pricing of a variance swap contract on the credit default swap derivatives.

15. The computer system of claim 1, wherein the at least one processor is further caused to:
create a standardized exchange-traded derivative instrument based on the credit volatility index; and
transmit data regarding the standardized exchange-traded derivative.

16. The computer system of claim 7, wherein transmitting data regarding the standardized exchange-traded derivative instrument includes transmitting data regarding one or more of a settlement price, a bid price, an offer price, or a trade price of the standardized exchange-traded derivative instrument.
